(19) United States
(12) Patent Application Publication
(10) Pub. No.: US 2026/0328588 A1
(43) Pub. Date: Oct. 22, 2026

(54) DATA PROCESSING METHOD AND RELATED APPARATUS

(71) Applicant: Tencent Technology (Shenzhen) Company Limited, Shenzhen (CN)

(72) Inventor: Tongxing XIAO, Shenzhen (CN)

(21) Appl. No.: 19/558,286

(22) Filed: Mar. 5, 2026

Related U.S. Application Data
(63) Continuation of application No. PCT/CN2024/111613, filed on Aug. 13, 2024.

(30) Foreign Application Priority Data
Nov. 10, 2023 (CN) 202311495692.7

(51) Int. Cl. G01C 21/00

(52) U.S. Cl. CPC G01C 21/3867; G01C 21/3826

(57) ABSTRACT

This application discloses a data processing method performed by a computer device. Absolute elevations of projection points respectively corresponding to a plurality of position points are extracted from terrain data. An elevation constraint condition set corresponding to the plurality of position points is generated according to a position relationship between the plurality of position points. An elevation distribution feature function is constructed by using relative elevation parameters respectively corresponding to the plurality of position points, and parameter solving is performed on the relative elevation parameters based on the elevation distribution feature function and the elevation constraint condition set, to obtain relative elevations respectively corresponding to the plurality of position points. An absolute elevation of the position point is obtained based on the relative elevation of the position point and the absolute elevation of the projection point corresponding to the position point.

### CROSS-REFERENCE TO RELATED APPLICATIONS

This application is a continuation application of PCT Patent Application No. PCT/CN2024/111613, entitled “DATA PROCESSING METHOD AND RELATED APPARATUS” filed on Aug. 13, 2024, which claims priority to Chinese Patent Application No. 2023114956927, entitled “DATA PROCESSING METHOD AND RELATED APPARATUS” filed with the China National Intellectual Property Administration on Nov. 10, 2023, all of which are incorporated herein by reference in their entirety.

### FIELD OF THE TECHNOLOGY

This application relates to the computer field, and in particular, to map data processing technologies.

### BACKGROUND OF THE DISCLOSURE

With the development of society, road traffic becomes increasingly complex, and people usually need to complete route planning, route navigation, and the like with the help of electronic maps during travel. To make the rendering of electronic maps aesthetically pleasing and as close to the real world as possible, the roads in electronic maps may be three-dimensional, that is, the roads in the electronic maps may include elevation information.

To generate an electronic map with elevation information, that is, a three-dimensional electronic map, elevation information of the roads needs to be obtained. The related art provides a method for generating elevation information of a road based on two-dimensional map data. However, the elevation information generated by using this method is not accurate enough, affecting a road rendering effect and reducing a sense of reality of a road elevation.

### SUMMARY

To resolve the foregoing technical problem, this application provides a data processing method and a related apparatus, so that an absolute elevation of a road can be determined. The absolute elevation can more accurately reflect a real height of a road. When road rendering is performed based on the absolute elevation, a road rendering effect can be improved, further improving a sense of reality of a road elevation, and providing stronger immersion to a user.

Embodiments of this application disclose the following technical solutions.

According to an aspect, an embodiment of this application provides a data processing method, performed by a computer device. The method includes:
obtaining terrain data and two-dimensional map data corresponding to a target road;
extracting, from the two-dimensional map data, a plurality of position points on the target road;
extracting, from the terrain data, absolute elevations of projection points respectively corresponding to the plurality of position points;
generating an elevation constraint condition set corresponding to the plurality of position points according to a position relationship between the plurality of position points based on the two-dimensional map data;
determining relative elevation parameters respectively corresponding to the plurality of position points based on the elevation constraint condition set; and
determining, for each position point, an absolute elevation of the position point based on the relative elevation of the position point and an absolute elevation of the projection point corresponding to the position point.

According to an aspect, an embodiment of this application provides a computer device. The computer device includes a processor and a memory.

The memory is configured to: store a computer program, and transmit the computer program to the processor; and

the processor is configured to perform the method according to any one of the foregoing aspects according to instructions in the computer program.

According to an aspect, an embodiment of this application provides a non-transitory computer-readable storage medium. The computer-readable storage medium is configured to store a computer program. The computer program, when executed by a processor, causes the processor to perform the method according to any one of the foregoing aspects.

According to an aspect, an embodiment of this application provides a computer program product, including a computer program. The computer program, when executed by a processor, implements the method according to any one of the foregoing aspects.

It can be seen from the foregoing technical solution that, a plurality of position points of a to-be-processed road are obtained from two-dimensional map data, and then absolute elevations of projection points respectively corresponding to the plurality of position points are extracted from terrain data. The absolute elevation is extracted from real terrain data. Because the terrain data can truly reflect a real terrain such as undulations of the terrain, the determined absolute elevation of the projection point is relatively accurate. A relative elevation of the position point is then determined, and in a process of determining the relative elevation, the determining of the relative elevation is converted into solving for a relative elevation parameter. Specifically, an elevation constraint condition set corresponding to the plurality of position points may be generated according to a determined position relationship between the plurality of position points. The elevation constraint condition set is configured for indicating conditions that need to be met by elevations respectively corresponding to the plurality of position points, and the elevation corresponding to each position point is represented by using a relative elevation parameter of the position point relative to a projection point corresponding to the position point. A specific value of the relative elevation parameter is unknown, that is, needs to be solved for. Therefore, an elevation distribution feature function may be constructed by using relative elevation parameters respectively corresponding to the plurality of position points, and parameter solving is performed on the relative elevation parameters based on the elevation distribution feature function and the elevation constraint condition set, to obtain relative elevations respectively corresponding to the plurality of position points. An absolute elevation of a position point is then obtained based on a relative elevation of the position point and an absolute elevation of a projection point corresponding to the position point. The absolute elevation can more accurately reflect a real height of a road. When road rendering is performed based on the absolute elevation, a road rendering effect can be improved, further improving a sense of reality of a road elevation, and providing stronger immersion to a user.

### BRIEF DESCRIPTION OF THE DRAWINGS

To more clearly describe the technical solutions in embodiments of this application or in the related art, accompanying drawings required for describing the embodiments or the related art are briefly described below. Apparently, the accompanying drawings in the following descriptions merely show some of the embodiments of this application, and a person of ordinary skill in the art may still derive other accompanying drawings according to these accompanying drawings without creative efforts.

FIG. 1 is an architectural diagram of an application scenario of a data processing method according to an embodiment of this application.

FIG. 2 is a flowchart of a data processing method according to an embodiment of this application.

FIG. 3 is an example diagram of a top view of a three-dimensional terrain mesh according to an embodiment of this application.

FIG. 4 is an example diagram of a road overlaying relationship according to an embodiment of this application.

FIG. 5 is an example diagram of a position relationship being a neighboring relationship according to an embodiment of this application.

FIG. 6 is an example diagram of a road adjacency relationship according to an embodiment of this application.

FIG. 7 is a flowchart of a method for determining an absolute elevation of a projection point according to an embodiment of this application.

FIG. 8 is a flowchart of another method for determining an absolute elevation of a projection point according to an embodiment of this application.

FIG. 9 is an example diagram of a top view of a to-be-processed road according to an embodiment of this application.

FIG. 10 is a structural diagram of a data processing apparatus according to an embodiment of this application.

FIG. 11 is a structural diagram of a terminal according to an embodiment of this application.

FIG. 12 is a structural diagram of a server according to an embodiment of this application.

### DESCRIPTION OF EMBODIMENTS

Embodiments of this application are described below with reference to the accompanying drawings.

For ease of understanding, related concepts are first described herein.

An absolute elevation refers to a distance from a position point to an absolute datum plane in a plumb line direction, and is referred to as an elevation for short.

A relative elevation refers to a distance from a position point to an assumed leveling datum plane in a plumb line direction, and is also referred to as an assumed elevation. In this application, a relative elevation of a road is considered as a height difference between a position point on the road and a corresponding point on the ground, and a set leveling datum plane is the ground. The corresponding point on the ground herein may be a projection point of the position point on the road on the ground.

An SD map, that is, a standard-definition map, is an ordinary navigation electronic map, which is generally two-dimensional, has no absolute elevation, and only has a height relationship between roads, that is, zlevel.

An HD map, that is, a high-definition map, is a highly accurate map, and can accurately and comprehensively represent a road feature.

Optimization is a branch of applied mathematics, and mainly refers to a method of selecting a research solution to optimize an objective under a certain condition.

Convex optimization is a sub-field of mathematical optimization, researching the problem of minimizing a convex function defined in a convex set. The convex optimization is simpler than a general mathematical optimization problem in a sense.

An interior-point method is an algorithm for solving a linear programming or nonlinear convex optimization problem.

When elevation information of a road is generated based on two-dimensional map data, the generated elevation information is usually a relative elevation of the road. Generally, the relative elevation is not accurate enough, and it is difficult to reflect a real height of the road. Consequently, a road rendering effect is affected, and a sense of reality of a road elevation is reduced.

To resolve the foregoing technical problem, an embodiment of this application provides a data processing method. According to the method, an absolute elevation of a position point is determined based on a relative elevation of the position point and an absolute elevation of a projection point corresponding to the position point. The absolute elevation can more accurately reflect a real height of a road. When road rendering is performed based on the absolute elevation, a road rendering effect can be improved, further improving a sense of reality of a road elevation, and providing stronger immersion to a user.

The data processing method provided in this embodiment of this application is applicable to the fields such as electronic maps, autonomous driving, assisted driving, intelligent traffic, cloud technologies, and artificial intelligence. In these fields, an electronic map may need to be generated. During rendering of a road on an electronic map, an absolute elevation of the road may be determined by using the method provided in this embodiment of this application, and then the road is rendered based on the absolute elevation. A scenario in which the electronic map is used may be, for example, a scenario such as autonomous driving, traffic management, city planning, tourism, logistics, gaming, virtual reality, or augmented reality. This is not limited in this embodiment of this application.

The data processing method for an electronic map provided in this embodiment of this application may be performed by a computer device. The computer device may be, for example, a server or a terminal. The server may be an independent physical server, a server cluster or distributed system including a plurality of physical servers, or a cloud server providing cloud computing services. The terminal includes, but is not limited to, a smartphone, a computer, an intelligent voice interaction device, a smart home appliance, an in-vehicle terminal, an aerial vehicle, and the like.

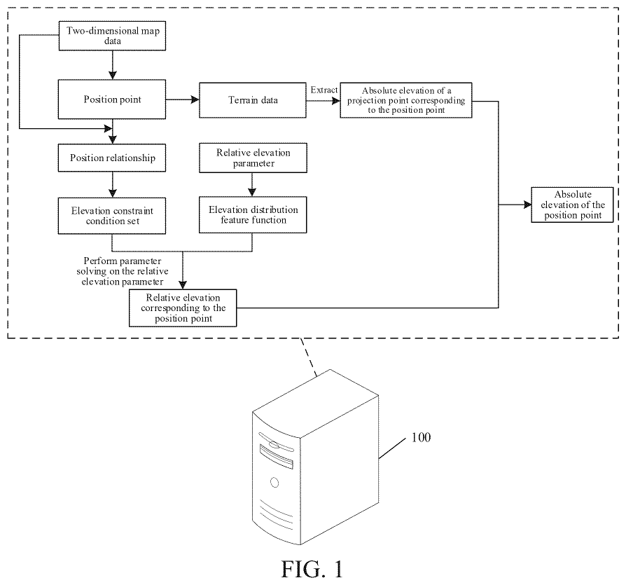

FIG. 1 is an architectural diagram of an application scenario of a data processing method according to an embodiment of this application. The application scenario is described by using an example in which a computer device performing the method is a server. The application scenario may include a server 100.

When a three-dimensional electronic map needs to be generated, elevation information of a road needs to be first determined. The elevation information herein may be an absolute elevation of the road, so that road rendering is performed based on the absolute elevation, to generate the three-dimensional electronic map with the elevation information.

To determine the absolute elevation of the road, the road may be first used as a to-be-processed road, so that the server 100 can obtain terrain data corresponding to the to-be-processed road and two-dimensional map data corresponding to the to-be-processed road. The to-be-processed road may be a road of which an absolute elevation currently needs to be determined for rendering. There may be one or more to-be-processed roads. The terrain data is data configured for reflecting a real terrain of a position of the to-be-processed road, and can reflect undulations of the terrain. Public data of the real terrain, that is, the terrain data, can be used. The terrain data is known. The two-dimensional map data is an ordinary navigation electronic map. Because an ordinary navigation electronic map is two-dimensional and can reflect a road network (namely, a two-dimensional road network) formed between roads, the ordinary navigation electronic map may also be referred to as two-dimensional road network data. The two-dimensional map data does not include the elevation information, but provides longitude information, latitude information, and a road relationship between roads.

Usually, the to-be-processed road may include many position points. Therefore, absolute elevations of all position points on the to-be-processed road may form the absolute elevation of the to-be-processed road. The absolute elevation of the position point may be formed by a relative elevation of the position point relative to a projection point and an absolute elevation of the projection point. Therefore, the server 100 may separately calculate the relative elevation of the position point relative to the projection point and the absolute elevation of the projection point. The projection point may be a projection point corresponding to the position point in the terrain data.

During calculation of the absolute elevation of the projection point, the server 100 may obtain the plurality of position points on the to-be-processed road from the two-dimensional map data, to extract, from the terrain data, absolute elevations of projection points respectively corresponding to the plurality of position points. The absolute elevation is extracted from real terrain data, and can truly reflect a real terrain status such as the undulations of the terrain.

The server 100 may then determine a relative elevation of the position point, and in a process of determining the relative elevation, convert the determining of the relative elevation into solving for a relative elevation parameter. The server 100 may specifically generate an elevation constraint condition set corresponding to the plurality of position points according to a determined position relationship between the plurality of position points. The elevation constraint condition set is configured for indicating conditions that need to be met by elevations respectively corresponding to the plurality of position points, and the elevation corresponding to each position point is represented by using a relative elevation parameter of the position point relative to a projection point corresponding to the position point. A specific value of the relative elevation parameter is unknown, that is, needs to be solved for. Therefore, the server 100 may construct an elevation distribution feature function by using relative elevation parameters respectively corresponding to the plurality of position points, and perform parameter solving on the relative elevation parameters based on the elevation distribution feature function and the elevation constraint condition set, to obtain relative elevations respectively corresponding to the plurality of position points.

The server 100 then obtains an absolute elevation of a position point based on a relative elevation of the position point and an absolute elevation of a projection point corresponding to the position point. The absolute elevation can more accurately reflect a real height of a road. When road rendering is performed based on the absolute elevation, a road rendering effect can be improved, further improving a sense of reality of a road elevation, and providing stronger immersion to a user.

In a specific implementation of this application, user information and other relevant data may be involved in the whole process. When the above embodiments of this application are applied to specific products or technologies, a separate consent or separate permission of a user needs to be obtained, and acquisition, use, and processing of relevant data need to comply with relevant laws, regulations, and standards of relevant countries and regions.

The method provided in this embodiment of this application may relate to artificial intelligence technologies, to automatically implement data processing through the artificial intelligence technologies. The elevation information obtained based on the data processing method in this embodiment of this application may be configured for generating a three-dimensional electronic map, for example, in the fields of autonomous driving, assisted driving, and intelligent traffic, to implement lane-level navigation based on a real terrain.

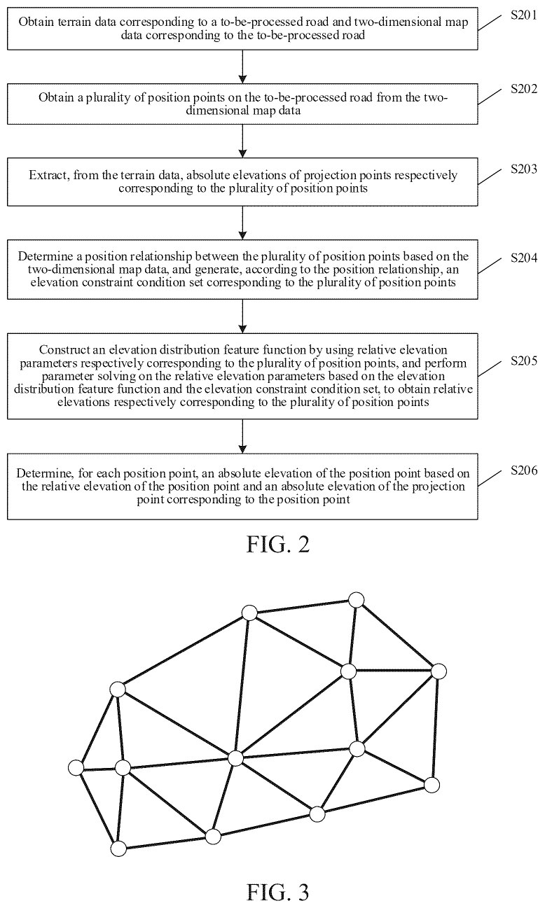

The data processing method provided in this embodiment of this application is described below with reference to the accompanying drawings by using the computer device as a server. Refer to FIG. 2. FIG. 2 is a flowchart of a data processing method. The method includes the following operations.

S201: Obtain terrain data corresponding to a to-be-processed road and two-dimensional map data corresponding to the to-be-processed road.

To determine an absolute elevation of a road, the road may be first used as a to-be-processed road, so that the server can obtain terrain data corresponding to the to-be-processed road and two-dimensional map data corresponding to the to-be-processed road. The to-be-processed road may be a road of which an absolute elevation currently needs to be determined for rendering. There may be one or more to-be-processed roads.

During road rendering, rendering may be performed by using a region divided in advance as a unit, that is, roads in one region are rendered each time. In this way, during determining of the absolute elevation of the road, the roads in one region may be used as to-be-processed roads, to calculate absolute elevations of position points on the to-be-processed roads. Regions may be divided according to cities, towns, position information, or the like. This is not limited in this embodiment of this application.

The terrain data is data configured for reflecting a real terrain of a position of the to-be-processed road, and can reflect undulations of the terrain. The terrain data is known and publicly used data, can be directly obtained and used, and is data with low obtaining costs, so that data processing costs are reduced.

A data format of the terrain data is not limited in this embodiment of this application. In a possible implementation, the terrain data may be a three-dimensional terrain mesh formed by a plurality of patches, and each vertex in the three-dimensional terrain mesh has an absolute elevation. The patches forming the three-dimensional terrain mesh may be of different shapes, for example, may be triangular, square, rectangular, and hexagonal. This is not limited in this application. An example in which the patch is a triangular patch is used. For a top view of a three-dimensional terrain mesh formed by a plurality of triangular patches, refer to FIG. 3. In FIG. 3, white circles represent vertexes of the three-dimensional terrain mesh, connection lines between the vertexes are referred to as edges of the three-dimensional terrain mesh, each triangle represents one triangular patch, and a list of vertexes or edges may be used to represent the triangular patch.

The two-dimensional map data is an ordinary navigation electronic map, and does not include elevation information, but provides longitude information, latitude information, and a road relationship between roads. The two-dimensional map data has low production costs, and is data with low obtaining costs, thereby reducing data processing costs.

S202: Obtain a plurality of position points on the to-be-processed road from the two-dimensional map data.

Usually, the to-be-processed road may include many position points.

Therefore, absolute elevations of all position points on the to-be-processed road may form the absolute elevation of the to-be-processed road. The absolute elevation of the position point may be formed by a relative elevation of the position point relative to a projection point corresponding to the position point and an absolute elevation of the projection point. Therefore, the server may separately calculate the relative elevation of the position point relative to the projection point corresponding to the position point and the absolute elevation of the projection point. The projection point corresponding to the position point may be a projection point corresponding to the position point in the terrain data, that is, projection is performed from the position point to a corresponding datum plane in the terrain data in a plumb line direction. A point obtained through the projection in this way is the projection point corresponding to the position point.

During calculation of the absolute elevation of the projection point, the server may obtain the plurality of position points on the to-be-processed road from the two-dimensional map data, to extract, from the terrain data, absolute elevations of projection points respectively corresponding to the plurality of position points. The absolute elevation is extracted from real terrain data, and can truly reflect a real terrain status such as undulations of a terrain.

In a possible implementation, the plurality of position points may be all position points on the to-be-processed road, so that the absolute elevation of the to-be-processed road may be directly obtained through S201 to S206. In another possible implementation, the plurality of position points may alternatively be a part of position points on the to-be-processed road. After absolute elevations of the part of position points are calculated by using the data processing method provided in this embodiment of this application, absolute elevations of remaining position points are obtained through interpolation by using the absolute elevations of the part of position points. Therefore, S201 to S206 do not need to be used to calculate the absolute elevation of each position point on the to-be-processed road, thereby reducing a related calculation amount and improving calculation efficiency.

When the plurality of position points are a part of position points on the to-be-processed road, the part of position points may be representative position points on the to-be-processed road. Such position points may be referred to as control points. The control points are usually obtained from the following two places:
\textcircled{1} a start point and an end point of a to-be-processed road; and
\textcircled{2} a position point of the to-be-processed road at an overlaying (overpass) position.

For a road, the road usually includes a start point and an end point. However, because the road does not necessarily have a road overlaying relationship with another road, determined control points may also be different.

In this case, a manner of obtaining the plurality of position points on the to-be-processed road from the two-dimensional map data may be: obtaining a start point and an end point of the to-be-processed road. Then, whether a road relationship corresponding to the to-be-processed road includes a road overlaying relationship is determined. Usually, the road relationship may be, for example, a road overlaying relationship, a road adjacency relationship, or no relationship. Because the two-dimensional map data can provide a road relationship, the road relationship corresponding to the to-be-processed road can be determined based on the two-dimensional map data. An overlaying point of the to-be-processed road is obtained if it is determined, based on the two-dimensional map data, that the road relationship corresponding to the to-be-processed road includes the road overlaying relationship, and the overlaying point, the start point, and the end point of the to-be-processed road are determined as the plurality of position points. The overlaying point is a position point located at an overlaying position on the to-be-processed road. The start point and the end point of the to-be-processed road are determined as the plurality of position points if it is determined, based on the two-dimensional map data, that the road relationship corresponding to the to-be-processed road does not include the road overlaying relationship.

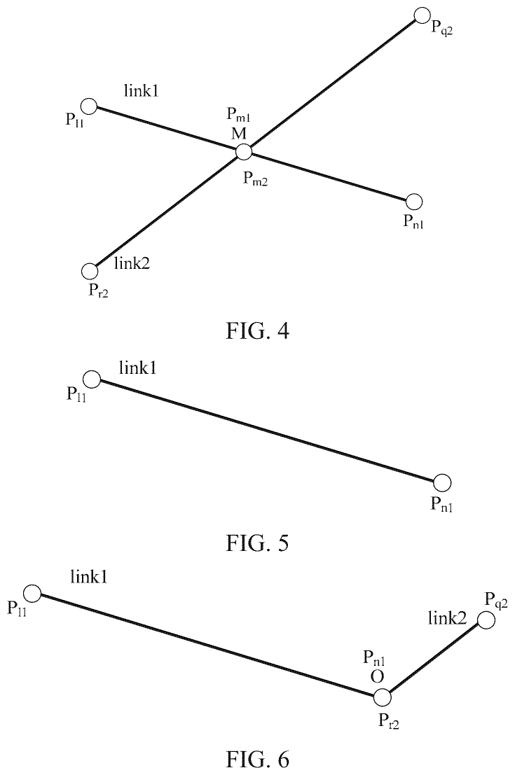

The road overlaying relationship represents that an overlapping region exists between a road and another road in a vertical direction in space. A height difference exists between two roads having the road overlaying relationship, that is, one road is high and one road is low. The road overlaying relationship may also be referred to as an overpass relationship, and an overlapping region of two roads may be referred to as an overlaying position. The two-dimensional map data provides a height relationship between roads. Therefore, whether the road relationship is the road overlaying relationship may be determined based on the two-dimensional map data. An example in which the to-be-processed road is a road 1 is used. The road 1 may be represented as link1. Refer to FIG. 4. FIG. 4 is a top view of link1 and link2 (that is, link1 and link2 are viewed from the vertical direction in space). A road relationship corresponding to the to-be-processed road link1 reflects a road overlaying relationship between link1 and link2. Because link1 and link2 in FIG. 4 are represented by line segments, an overlapping region of link1 and link2 may be a point, that is, the overlaying position may be a point M in FIG. 4. link1 and link2 separately include a plurality of position points. A position point on link1 located at the overlaying position is shown by Pₘ₁ in FIG. 4, and a position point on link2 located at the overlaying position is shown by Pₘ₂ in FIG. 4. Therefore, the road relationship corresponding to the to-be-processed road link1 includes the road overlaying relationship, and an overlaying point on link1 is Pₘ₁. If a start point of link1 is Pₗ₁, and an end point of link1 is Pₙ₁, a plurality of position points of link1 may include Pₗ₁, Pₙ₁, and Pₘ₁. If the to-be-processed road includes a plurality of roads, a position point for calculating an elevation on another road may be determined according to the foregoing method.

In this way, in the foregoing manner, with reference to the road relationship corresponding to the to-be-processed road indicated by the two-dimensional map data, position points on the to-be-processed road whose absolute elevations need to be calculated are determined, thereby ensuring that the determined position points are representative. After absolute elevations of such position points are determined, the absolute elevation of the to-be-processed road can be more accurately determined.

S203: Extract, from the terrain data, absolute elevations of projection points respectively corresponding to the plurality of position points.

In this embodiment of this application, an absolute elevation of a position point may be formed by a relative elevation of the position point relative to a projection point corresponding to the position point and an absolute elevation of the projection point. Therefore, after obtaining the position point, the absolute elevation of the projection point corresponding to the position point in the terrain data and the relative elevation of the position point relative to the projection point may be separately calculated. During calculation of the relative elevation of the position point relative to the projection point corresponding to the position point, an elevation constraint condition may be constructed by using the absolute elevation of the projection point corresponding to the position point in the terrain data. Therefore, the absolute elevation of the projection point corresponding to the position point in the terrain data may be calculated first.

The projection point corresponding to the position point in the terrain data may be a projection point obtained by projecting the position point to the terrain data in the vertical direction in space. When the terrain data is the three-dimensional terrain mesh including a plurality of patches, because each vertex in the three-dimensional terrain mesh carries data of an absolute elevation, the absolute elevation of the projection point may be determined based on an absolute elevation of a vertex of a patch on which the projection point is located.

S204: Determine a position relationship between the plurality of position points based on the two-dimensional map data, and generate an elevation constraint condition set corresponding to the plurality of position points according to the position relationship.

The server may then determine the relative elevation of the position point relative to the projection point corresponding to the position point, and in a process of determining the relative elevation, the server converts the determining of the relative elevation into solving for a relative elevation parameter. Specifically, the server may determine the position relationship between the plurality of position points based on the two-dimensional map data, and generate the elevation constraint condition set corresponding to the plurality of position points according to the position relationship between the plurality of position points.

In this embodiment of this application, the position points are located on the to-be-processed road. In this way, the road relationship corresponding to the to-be-processed road affects the position relationship between the position points. Usually, for one to-be-processed road, the to-be-processed road may include at least two position points for calculating an elevation. Therefore, for the at least two position points on the to-be-processed road, there are neighboring position points in the at least two position points, that is, there is at least a neighboring relationship between the position points. Whether there is another position relationship may be further determined according to the road relationship corresponding to the to-be-processed road.

In this case, an implementation of determining the position relationship between the plurality of position points based on the two-dimensional map data may be as follows: From the plurality of position points, any two neighboring position points belonging to a same to-be-processed road are obtained, and it is determined that the two neighboring position points have a neighboring relationship. Then, the road relationship corresponding to the to-be-processed road is determined based on the two-dimensional map data, and the position relationship between the plurality of position points is determined according to the road relationship corresponding to the to-be-processed road and the neighboring relationship between the two neighboring position points.

According to different road relationships, the position relationship between the plurality of position points determined according to the road relationship and the neighboring relationship between the two neighboring position points may be different. If the road relationship corresponding to the to-be-processed road reflects that there is no road relationship between the to-be-processed road and another road, the neighboring relationship between the two neighboring position points may be determined as the position relationship between the plurality of position points. That there is no road relationship between the to-be-processed road and another road may mean that there is only one to-be-processed road, or that the to-be-processed road includes a plurality of roads, but the plurality of roads are parallel to each other on a same horizontal plane, or the like.

For example, FIG. 5 includes only one to-be-processed road link1, and the to-be-processed road includes two position points, namely, Pₗ₁ and Pₙ₁. Pₗ₁ and Pₙ₁ are neighboring, and a position relationship between Pₗ₁ and Pₙ₁ is the neighboring relationship.

If the road relationship includes the road overlaying relationship, position points corresponding to an overlaying position are obtained from the to-be-processed road having the road overlaying relationship, and it is determined that the position points corresponding to the same overlaying position have an upper-lower relationship. Further, the upper-lower relationship between the position points corresponding to the same overlaying position and the neighboring relationship between the two neighboring position points are determined as the position relationship between the plurality of position points.

For example, FIG. 4 is the top view of link1 and link2, and a road relationship between link1 and link2 is the road overlaying relationship. Position points of link1 may be Pₗ₁, Pₙ₁, and Pₘ₁. Position points of link2 may be Pᵣ₂, P_{q2}, and Pₘ₂. An overlaying position of link1 and link2 is a position indicated by the point M. Correspondingly, a position point on link1 located at the overlaying position is Pₘ₁. A position point on link2 located at the overlaying position is Pₘ₂. Therefore, Pₘ₁ and Pₘ₂ have the upper-lower relationship. Among the three position points on link1, Pₗ₁ and Pₘ₁ are neighboring, and Pₘ₁ and Pₙ₁ are neighboring. Therefore, Pₗ₁ and Pₘ₁ have the neighboring relationship, and Pₘ₁ and Pₙ₁ have the neighboring relationship. Similarly, on link2, Pᵣ₂ and Pₘ₂ have the neighboring relationship, and Pₘ₂ and P_{q2} have the neighboring relationship. Therefore, for the plurality of position points Pₗ₁, Pₙ₁, Pₘ₁, Pᵣ₂, P_{q2}, and Pₘ₂, the position relationship between the plurality of position points includes the upper-lower relationship between Pₘ₁ and Pₘ₂, the neighboring relationship between Pₗ₁ and Pₘ₁, the neighboring relationship between Pₘ₁ and Pₙ₁, the neighboring relationship between Pᵣ₂ and Pₘ₂, and the neighboring relationship between Pₘ₂ and P_{q2}.

If the road relationship includes a road adjacency relationship, position points corresponding to a connection position are obtained from the to-be-processed road having the road adjacency relationship, and it is determined that the position points corresponding to the same connection position have an adjacency relationship. Further, the adjacency relationship between the position points corresponding to the same connection position and the neighboring relationship between the two neighboring position points are determined as the position relationship between the plurality of position points.

The road adjacency relationship represents that two roads are connected in a head-to-tail manner, that is, an end point of a road coincides with a start point of another road. A position at which two roads are connected may be referred to as a connection position. For example, FIG. 6 is a top view of link1 and link2. link1 and link2 are connected at a point O, that is, an end point Pₙ₁ of link1 and a start point Pᵣ₂ of link2 coincide at the point O. Therefore, a road relationship between link1 and link2 is the road adjacency relationship. Position points of link1 may be Pₗ₁ and Pₙ₁, and position points of link2 may be Pᵣ₂ and P_{q2}. A connection position between link1 and link2 is a position indicated by the point O. Correspondingly, a position point on link1 at the connection position is Pₙ₁, and a position point on link2 at the connection position is Pᵣ₂. Therefore, Pₙ₁ and Pᵣ₂ have the adjacency relationship. The two position points Pₗ₁ and Pₙ₁ on link1 are neighboring. Therefore, Pₗ₁ and Pₙ₁ have the neighboring relationship. Similarly, on link2, Pᵣ₂ and P_{q2} have the neighboring relationship. Therefore, for the plurality of position points Pₗ₁, Pₙ₁, Pᵣ₂, and P_{q2}, the position relationship between the plurality of position points includes the neighboring relationship between Pₗ₁ and Pₙ₁, the neighboring relationship between Pᵣ₂ and P_{q2}, and the adjacency relationship between Pₙ₁ and Pᵣ₂.

If the road relationship includes the road overlaying relationship and the road adjacency relationship, position points corresponding to an overlaying position are obtained from the to-be-processed road having the road overlaying relationship, and it is determined that the position points corresponding to the same overlaying position have an upper-lower relationship. Position points corresponding to a connection position are obtained from the to-be-processed road having the road adjacency relationship, and it is determined that the position points corresponding to the same connection position have an adjacency relationship. Further, the upper-lower relationship between the position points corresponding to the same overlaying position, the adjacency relationship between the position points corresponding to the same connection position, and the neighboring relationship between the two neighboring position points are determined as the position relationship between the plurality of position points.

In this way, in the foregoing manner, the position relationship between the position points on each to-be-processed road is determined based on the road overlaying relationship and the road adjacency relationship between the to-be-processed roads, thoroughly and comprehensively determining the position relationship between the plurality of position points. It further facilitates ensuring that an elevation constraint condition set subsequently constructed based on the position relationship can comprehensively constrain a condition that a generated elevation needs to meet, thereby improving accuracy of a determined relative elevation.

The elevation constraint condition set is configured for indicating conditions that need to be met by elevations respectively corresponding to the plurality of position points, and the elevation corresponding to each position point is represented by using a relative elevation parameter of the position point relative to a projection point corresponding to the position point.

In a possible implementation, the elevation corresponding to the position point may be a relative elevation. In this case, the relative elevation of each position point only needs to be represented by the relative elevation parameter of the position point relative to the projection point corresponding to the position point.

In another possible implementation, considering that the ground is not necessarily horizontal but there are undulations in a terrain, during construction of the elevation constraint condition set, the undulations in the terrain may also be considered. In this case, the elevation corresponding to the position point may be an absolute elevation, and the absolute elevation of each position point is represented by the relative elevation parameter of the position point relative to the projection point corresponding to the position point and an absolute elevation of the projection point corresponding to the position point. Because an absolute elevation in the elevation constraint condition is represented by a relative elevation parameter of a position point relative to a projection point corresponding to the position point and an absolute elevation of the projection point corresponding to the position point, and the absolute elevation of the projection point corresponding to the position point is determined based on real terrain data, in a solving process, the terrain data and the two-dimensional map data are combined to construct the elevation constraint condition, and the undulations in the terrain are considered, so that the solved relative elevation can be more accurate.

The elevation constraint condition set is a set formed by elevation constraint conditions. One elevation constraint condition is usually constructed by using absolute elevations of two position points having a position relationship. Based on this, a manner of generating the elevation constraint condition set corresponding to the plurality of position points according to the position relationship between the plurality of position points may be as follows: A plurality of position point pairs having the position relationship are obtained according to the position relationship between the plurality of position points. An elevation constraint condition corresponding to the position point pair is generated according to the position relationship of the position point pair, to construct the elevation constraint condition set based on the elevation constraint condition corresponding to each position point pair.

According to different position relationships, the elevation constraint conditions may also be different. One elevation constraint condition may be, for example, an overlaying height constraint condition, a road slope constraint condition, or a height continuity constraint condition at an adjacency point.
1. Overlaying height constraint. The two-dimensional map data can provide a height relationship between two roads that have a road overlaying relationship, but does not provide a height difference between the two roads at an overlaying position. The height difference between the two roads at the overlaying position cannot be excessively small, otherwise, it seems that the two roads are approximately stacked, and a visual effect is poor. Therefore, a minimum height difference at the overlaying position needs to be controlled.

A height of a road may be represented by an elevation. When an elevation corresponding to a position point is an absolute elevation, assuming that a position point on an upper to-be-processed road located at an overlaying position is Pᵤ, and a position point on a lower to-be-processed road located at the overlaying position is P_{d}, a position point pair formed by Pᵤ and P_{d} have an upper-lower relationship. In a top view, the two position points overlap, and projection points of the two position points on the terrain data are necessarily a same point.

Therefore, to ensure that a difference between absolute elevations of the two position points meets a requirement, the absolute elevation of the position point may be represented by an absolute elevation of a corresponding projection point and a relative elevation of the position point relative to the projection point. Because the projection points of the two position points are the same point, that is, absolute elevations of the projection points are the same, it only needs to be ensured that a difference between relative elevations of the two position points relative to the projection point meets the requirement. Therefore, the overlaying height constraint is:

hᵤ−h_{d}≥H (1)
where hᵤ is a relative elevation parameter of Pᵤ relative to the projection point, ha is a relative elevation parameter of P_{d} relative to the projection point, and His a minimum overlaying height, namely, a height difference threshold, and may be set according to an actual requirement. In a possible implementation, H may be 4 meters in practice. In a process of calculating the relative elevation of the position point, because the relative elevation is unknown and needs to be solved for, the relative elevation parameter of the position point is used in the overlaying height constraint to replace the relative elevation, and a specific value corresponding to the relative elevation parameter, namely, the relative elevation, needs to be solved for.

When a target elevation is the relative elevation, it is ensured that the difference between relative elevations of the two position points relative to the projection points meets the requirement. For the overlaying height constraint, refer to formula (1).
2. Road slope constraint. An absolute elevation of a position point needs to meet a condition that a change of a road slope is gentle, and a case in which the road slope suddenly increases and suddenly decreases cannot occur. Therefore, a maximum value of the road slope needs to be controlled.

For any two neighboring position points Pₚ and Pₙ on any road, a position point pair formed by Pₚ and Pₙ have the neighboring relationship.

When an elevation corresponding to a position point is an absolute elevation, it is assumed that an absolute elevation of a projection point of Pₚ on the terrain data is

$${h}_{p}^{a} ,$$

and a relative elevation parameter of Pₚ relative to the projection point is hₚ; and an absolute elevation of a projection point of Pₙ on the terrain data is

$${h}_{n}^{a} ,$$

and a relative elevation parameter of Pₙ relative to the projection point is hₙ. Therefore, the road slope constraint is:

$$- {S}_{p n} {D}_{p n} \leq ( {h}_{p}^{a} + {h}_{p} ) - ( {h}_{n}^{a} + {h}_{n} ) \leq {S}_{p n} {D}_{p n} \qquad ( 2 )$$

where Sₚₙ is a tangent of a maximum slope between Pₚ and Pₙ. The maximum slope is a slope threshold, and may be 1 degree in practice. Dₚₙ is a distance between Pₚ and Pₙ on a plane. After two-dimensional position information (for example, longitude and latitude coordinates) of a target position point is known, Dₚₙ can be calculated, and therefore is a known quantity.

When the elevation corresponding to the position point is a relative elevation, the road slope constraint is:

−SₚₙDₚₙ≤hₚ−hₙ≤SₚₙDₚₙ (3)
3. Adjacency height continuity constraint. Two roads having the road adjacency relationship need to be continuous at a connection position, otherwise there is a sudden height change at the connection position, that is, one road is high and the other road is low, affecting a visual effect.

Usually, the two roads having the road adjacency relationship may be a preceding road and a succeeding road. When an elevation corresponding to a position point is an absolute elevation, it is assumed that an end point of the preceding road is Pₑ, a start point of the succeeding road is Pₛ, and Pₑ and Pₛ are used as position points, that is, a position point pair formed by Pₑ and Pₛ has the adjacency relationship. In a top view, the two position points overlap, and projection points of the two position points on the terrain data are necessarily a same point. Therefore, to ensure that absolute elevations of the two position points are equal (that is, continuous), it only needs to be ensured that relative elevations of the two position points relative to the projection point are equal. That is, the adjacency height continuity constraint is:

hₑ=hₛ (4)
where hₑ is a relative elevation parameter of Pₑ relative to a projection point, and hₛ is a relative elevation parameter of Pₛ relative to the projection point. In a process of calculating the relative elevation of the position point, because the relative elevation is unknown and needs to be solved for, the relative elevation parameter of the position point is used in the adjacency height continuity constraint to replace the relative elevation, and a specific value corresponding to the relative elevation parameter, namely, the relative elevation, needs to be solved for.

When an elevation corresponding to a position point is the relative elevation, it is ensured that relative elevations of the two position points relative to the projection point are equal. For the adjacency height continuity constraint, refer to formula (4).

Based on the foregoing descriptions of the different elevation constraint conditions, a manner of generating the elevation constraint condition corresponding to the position point pair according to the position relationship of the position point pair may be: generating, if the position relationship of the position point pair is the upper-lower relationship, the elevation constraint condition corresponding to the position point pair according to upper-lower elevation information of the two position points in the position point pair and a height difference threshold. In this case, the elevation constraint condition is the overlaying height constraint. For an expression manner, refer to formula (1). The upper-lower relationship may be configured for indicating a height relationship between two position points in a position point pair, that is, an absolute elevation of a position point is higher and an absolute elevation of a position point is lower, so that relative elevation parameters of the two position points are correctly substituted into formula (1), to obtain the overlaying height constraint.

If the position relationship of the position point pair is the neighboring relationship, the elevation constraint condition corresponding to the position point pair is generated according to two-dimensional position information respectively corresponding to the two position points in the position point pair and a slope threshold. In this case, the elevation constraint condition is the road slope constraint. For an expression manner, refer to formula (2) or formula (3). The two-dimensional position information respectively corresponding to the two position points is configured for calculating a distance between the two position points on a plane, and the slope threshold is configured for calculating a tangent of a maximum slope. In addition, absolute elevations of the two position points relative to respective projection points may be calculated through S203. Relative elevations respectively corresponding to the two position points are unknown and may be represented by using relative elevation parameters. The tangent of the maximum slope, the distances between the two position points on the plane, the absolute elevations of the two position points relative to the respective projection points, and the relative elevation parameters respectively corresponding to the two position points are substituted into formula (2), to obtain the road slope constraint. Alternatively, the tangent of the maximum slope, the distance between the two position points on the plane, and the relative elevation parameters respectively corresponding to the two position points are substituted into formula (3), to obtain the road slope constraint.

If the position relationship of the position point pair is the adjacency relationship, an elevation constraint condition configured for indicating that the two position points in the position point pair are connected is generated as the elevation constraint condition corresponding to the position point pair. In this case, the elevation constraint condition is the adjacency height continuity constraint. For an expression manner, refer to formula (4). Relative elevations respectively corresponding to the two position points are unknown and may be represented by using relative elevation parameters. The relative elevation parameters respectively corresponding to the two position points are substituted into formula (4), to obtain the adjacency height continuity constraint.

In this way, in the foregoing manner, according to the position relationship of the position point pair, the corresponding elevation constraint condition configured for indicating the position relationship is constructed, to ensure that the constructed elevation constraint condition clearly reflects the position relationship of the position point pair. Correspondingly, solving for the relative elevation parameter corresponding to the position point based on the elevation constraint condition is also conducive to ensuring that the calculated relative elevation is accurate.

S205: Construct an elevation distribution feature function by using the relative elevation parameters respectively corresponding to the plurality of position points, and perform parameter solving on the relative elevation parameters based on the elevation distribution feature function and the elevation constraint condition set, to obtain relative elevations respectively corresponding to the plurality of position points.

In this embodiment of this application, the determining of the relative elevation is converted into a mathematical problem of solving for an optimal solution, that is, the determining of the relative elevation is converted into solving for the relative elevation parameter. A specific value of the relative elevation parameter is unknown, and the relative elevation parameter is a parameter configured for referring to a relative elevation of a position point relative to a projection point corresponding to the position point, that is, is a parameter that needs to be solved for. Therefore, the relative elevation parameter is used as an optimization variable (a decision variable). The elevation distribution feature function is constructed, so that parameter solving is performed on the relative elevation parameters based on the elevation distribution feature function and the elevation constraint condition set, to obtain the relative elevations respectively corresponding to the plurality of position points.

In a possible implementation, the relative elevations corresponding to the position points are as concentrated as possible. Squares of the relative elevation parameters of all the position points may be added to construct the elevation distribution feature function. An expression of the elevation distribution feature function may be:

$$V = {\sum }_{i = 1}^{n} {h}_{i}^{2} \qquad ( 5 )$$

where V represents distribution feature information, n is a total quantity of position points, and hᵢ represents a relative elevation parameter of an i^{th} position point. The relative elevations of the position points are unknown, and may be represented by using the relative elevation parameters.

If a generated road elevation is closer to a real terrain, a relative elevation of a position point on the road relative to a projection point of the position point on the terrain data is smaller. Therefore, in a process of performing parameter solving on the relative elevation parameters based on the elevation distribution feature function and the elevation constraint condition set, minimizing the distribution feature information determined based on the elevation distribution feature function may be used as an objective, and an optimal value, namely, the relative elevation, corresponding to the relative elevation parameter is solved for with reference to the elevation constraint condition set.

In a possible implementation, the elevation distribution feature function may be located in an elevation optimizer, so that parameter solving is performed by using the elevation optimizer, to obtain the relative elevations respectively corresponding to the plurality of position points.

In a parameter solving process, an initial relative elevation corresponding to each relative elevation parameter may be first obtained, and initial distribution feature information corresponding to the plurality of initial relative elevations is determined based on the plurality of initial relative elevations and the elevation distribution feature function. The plurality of initial relative elevations are then respectively adjusted based on initial distribution feature information and the elevation constraint condition set, to obtain the relative elevations respectively corresponding to the plurality of position points.

An obtaining source of the initial relative elevation is not limited in this embodiment of this application, and the initial relative elevation may be randomly generated or may be a fixed value. For example, the initial relative elevation corresponding to each relative elevation parameter may be 0.

The initial distribution feature information may be determined by substituting the initial relative elevation into the elevation distribution feature function. If the initial distribution feature information does not reach a target, or the plurality of initial relative elevations do not satisfy the elevation constraint condition in the elevation constraint condition set, the plurality of initial relative elevations are respectively adjusted, until distribution feature information calculated based on adjusted relative elevations reaches the target, and the plurality of initial relative elevations meet the elevation constraint condition in the elevation constraint condition set. In this case, the relative elevations of the position points are used as the relative elevations respectively corresponding to the plurality of position points.

There are many mature mathematical tools that can be used in the mathematical optimization, for example, an interior-point method in the convex optimization. Parameter solving can be performed efficiently by using these mathematical tools. In this embodiment of this application, a relative elevation optimizer is generated by using an optimization idea. The mathematical optimization tool is not limited in this embodiment of this application, and may be any optimization tool.

By using the foregoing parameter solving manner, in an entire parameter solving process, the relative elevation parameter may be continuously adjusted by using an optimization tool, to obtain the relative elevation meeting the target and the elevation constraint condition set. This process does not need additional prior knowledge or manual intervention, and fully automatic and low-cost calculation can be performed.

S206: Determine, for each position point, an absolute elevation of the position point based on the relative elevation of the position point and an absolute elevation of the projection point corresponding to the position point.

After obtaining the relative elevation of the position point relative to the projection point corresponding to the position point and the absolute elevation of the projection point corresponding to the position point, the server may obtain the absolute elevation of the position point based on the relative elevation of the position point relative to the projection point corresponding to the position point and the absolute elevation of the projection point corresponding to the position point. For example, the relative elevation of the position point and the absolute elevation of the projection point corresponding to the position point may be added to obtain the absolute elevation of the position point.

After the absolute elevation of the position point is obtained, the absolute elevation of the to-be-processed road may be obtained based on the absolute elevation of the position point, thereby performing road rendering based on the absolute elevation of the to-be-processed road.

Manners of determining the absolute elevation of the to-be-processed road may be different according to different selected position points. If the plurality of position points are all position points of the to-be-processed road, absolute elevations of the plurality of position points may be directly used as the absolute elevation of the to-be-processed road.

If the plurality of position points are a part of the position points on the to-be-processed road, absolute elevations of other position points on the to-be-processed road further need to be calculated. In this case, the server may obtain, from the two-dimensional map data, a position point on the to-be-processed road other than the plurality of position points, as an intermediate position point. A position point having a neighboring relationship with the intermediate position point is obtained from the plurality of position points, and is used as a reference position point. Interpolation is then performed according to an absolute elevation of the reference position point, to obtain an absolute elevation of the intermediate position point. The absolute elevations respectively corresponding to the plurality of position points and the absolute elevation of the intermediate position point are determined as the absolute elevation of the to-be-processed road.

For example, as shown in FIG. 6, for link1, after absolute elevations of Pₗ₁ and Pₙ₁ are calculated, absolute elevations of all position points between Pₗ₁ and Pₙ₁ are calculated through interpolation. A manner of interpolation is not limited in this embodiment of this application, for example, linear interpolation may be performed.

In this way, in the foregoing manner, interpolation is performed based on the determined absolute elevations of the position points, so that an absolute elevation of another position point on the to-be-processed road can be quickly and accurately determined. In this way, the absolute elevation of the to-be-processed road is further determined, thereby ensuring accuracy of the absolute elevation of the to-be-processed road, and further facilitating improving a road rendering effect.

It can be seen from the foregoing technical solution that, a plurality of position points of a to-be-processed road are obtained from two-dimensional map data, and then absolute elevations of projection points respectively corresponding to the plurality of position points are extracted from terrain data. The absolute elevation is extracted from real terrain data. Because the terrain data can truly reflect a real terrain such as undulations of the terrain, the determined absolute elevation of the projection point is relatively accurate. A relative elevation of the position point is then determined, and in a process of determining the relative elevation, the determining of the relative elevation is converted into solving for a relative elevation parameter. Specifically, an elevation constraint condition set corresponding to the plurality of position points may be generated according to a determined position relationship between the plurality of position points. The elevation constraint condition set is configured for indicating conditions that need to be met by elevations respectively corresponding to the plurality of position points, and the elevation corresponding to each position point is represented by using a relative elevation parameter of the position point relative to a projection point corresponding to the position point. A specific value of the relative elevation parameter is unknown, that is, needs to be solved for. Therefore, an elevation distribution feature function may be constructed by using relative elevation parameters respectively corresponding to the plurality of position points, and parameter solving is performed on the relative elevation parameters based on the elevation distribution feature function and the elevation constraint condition set, to obtain relative elevations respectively corresponding to the plurality of position points. An absolute elevation of a position point is then obtained based on a relative elevation of the position point and an absolute elevation of a projection point corresponding to the position point. The absolute elevation can more accurately reflect a real height of a road. When road rendering is performed based on the absolute elevation, a road rendering effect can be improved, further improving a sense of reality of a road elevation, and providing stronger immersion to a user.

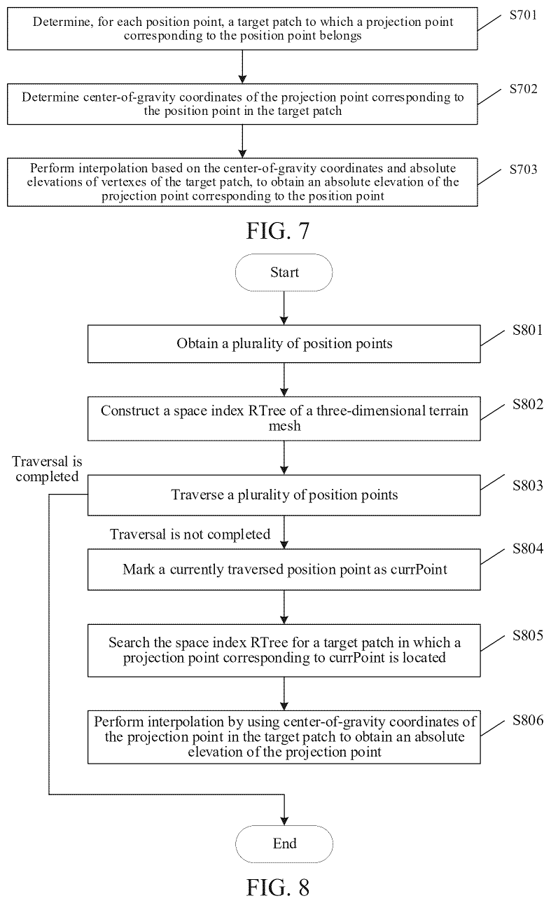

The foregoing embodiment describes a specific implementation of determining an absolute elevation of a position point. The absolute elevation of the position point may be represented by using a relative elevation of the position point relative to a projection point corresponding to the position point and an absolute elevation of the projection point. The absolute elevation of the projection point plays an important role in determining the absolute elevation of the position point. The following describes the method for determining the absolute elevation of the projection point in S203 in detail by using an example in which the terrain data is a three-dimensional terrain mesh formed by a plurality of patches. Refer to FIG. 7. The method includes the following operations.

S701: Determine, for each position point, a target patch to which the projection point corresponding to the position point belongs.

After obtaining the plurality of position points, the server determines, for each position point in the plurality of position points, a patch to which the projection point corresponding to the position point belongs, that is, obtains the target patch. The plurality of position points may be stored in a control point list. The control point list is represented as controlPointList, a position point that needs to be determined currently may be marked as currPoint, and the target patch to which the projection point corresponding to the position point belongs may be marked as polygon.

This embodiment of this application provides a plurality of manners of determining the target patch. In a possible implementation, because an absolute elevation of a position point is an unknown quantity, two-dimensional position information of the position point is known, and two-dimensional position information of a vertex of each patch in the three-dimensional terrain mesh is also known, the server may sequentially perform, for each position point based on the two-dimensional position information, determining on each patch in the three-dimensional terrain mesh to determine whether a projection point of the position point is located in the patch, thereby obtaining the target patch. The two-dimensional position information may be represented, for example, by using longitude and latitude coordinates or plane coordinate system coordinates (for example, XY coordinates).

In another possible implementation, a manner of determining the target patch to which the projection point corresponding to the position point belongs may be: creating a space index of the plurality of patches included in the three-dimensional terrain mesh, querying, by using the space index, for candidate patches corresponding to the position point, and further determining the target patch to which the projection point corresponding to the position point belongs from the candidate patches.

In a space index manner, the candidate patches near the position point may be first selected, and then determining only needs to be performed on the candidate patches separately, to determine a candidate patch in which the projection point corresponding to the position point is located. There is no need to perform determining on each patch in the three-dimensional terrain mesh, thereby reducing a calculation amount and improving efficiency of determining the target patch.

A form of the space index is not limited in this embodiment of this application. In a possible implementation, the space index may be RTree. RTree is an efficient data structure, and spatial data query can be efficiently performed. By using the RTree, a patch (that is, a candidate patch) near a position point can be efficiently queried for, that is, a patch on which the position point may be projected can be determined. Because an absolute elevation of a position point is unknown, when RTree is used for querying, two-dimensional position information of the target position point is used for querying.

A manner of constructing the space index RTree may be: creating a corresponding circumscribed rectangle by using two-dimensional position information (an absolute elevation is ignored) of each vertex on each patch, and constructing the space index RTree by using circumscribed rectangles corresponding to all the patches.

In this embodiment of this application, after the candidate patches are obtained, that is, after patches near a position point are found, a patch on which the position point falls further needs to be specifically determined, that is, the target patch is determined from the candidate patches.

A manner of determining the target patch from the candidate patches may be: for each candidate patch, determining whether a projection point of a position point is in the candidate patch, to determine the candidate patch including the projection point as the target patch. There may be a plurality of manners of determining whether a projection point is located on a candidate patch. When the candidate patch is a triangular patch, a manner for determining the target patch from the candidate patches may be an interior-angle sum method, a same direction method, or a center of gravity method.

Interior-angle sum method: A projection point P of a position point is connected to three vertexes of the triangular patch, to obtain three line segments. If the three vertexes of the triangular patch are respectively A, B, and C, the three line segments obtained by connecting the projection point P and the three vertexes of the triangular patch are respectively PA, PB, and PC. Angles respectively between the three line segments and sides of the triangular patch are obtained. If a sum of all angles is 180 degrees, the projection point P is in the triangular patch; otherwise, the projection point P is not in the triangular patch.

Same direction method: It is assumed that a projection point of a position point is P, and three vertexes of the triangular patch are respectively A, B, and C. If the projection point P is located in the triangular patch, there is such a rule that when walking on three sides in a direction of ABCA, it is found that the projection point P is always located on the right side of sides AB, BC, and CA. When a line segment AB is selected, the point C is located on a right side of AB. Similarly, when BC is selected, the point A is located on a right side of BC. Finally, when CA is selected, the point B is located on a right side of CA. Therefore, when a side is selected, it can be determined whether the projection point is on a left side or a right side of the side provided that whether the projection point P and a vertex opposite to the side are on a same side is verified. A manner of determining that two points are on a same side of a line segment may be: connecting PA, obtaining a cross product of PA and AB, and then obtaining a cross product of CA and AB, and determining, if directions of results of the two cross products are consistent, that the two points are on the same side. Determining whether two vectors are in a same direction may be implemented by using a dot product. If the dot product is greater than 0, an angle between the two vectors is an acute angle; otherwise, the angle between the two vectors is an obtuse angle.

In some cases, the projection point of the position point may be located in the patch, or may be located on an edge or at a vertex of the three-dimensional terrain mesh, that is, on an edge or at a vertex of the patch. In the three-dimensional terrain mesh, one edge or vertex may be shared by a plurality of patches. In this case, a manner of determining the target patch to which the projection point corresponding to the position point belongs may be: if the projection point corresponding to the position point is located on a target edge or at a target vertex of the three-dimensional terrain mesh, determining any patch on which the target edge or the target vertex is located as the target patch.

S702: Determine center-of-gravity coordinates of the projection point corresponding to the position point in the target patch.

After the target patch is determined, the center-of-gravity coordinates of the projection point corresponding to the position point in the target patch may be calculated. In mathematics, the center-of-gravity coordinates are coordinates defined by vertexes of a simplex (such as a triangle or a tetrahedron), and the center-of-gravity coordinates are a type of homogeneous coordinates. A calculation manner of the center-of-gravity coordinates is not limited in this embodiment of this application.

When a patch is a triangular patch, the center-of-gravity coordinates are also referred to as area coordinates. It is assumed that vertexes of the triangular patch are respectively A, B, and C. Center-of-gravity coordinates of a projection point P with respect to the triangular patch ABC are proportional to (directed) areas of triangles PBC, PCA, and PAB. It is assumed that a ratio of the areas of the PBC, the PCA, and the PAB is λ₁:λ₂:λ₃, and λ₁+λ₂+λ₃=1. Coordinates of A, B, and C are known. The center-of-gravity coordinates (λ₁,λ₂,λ₃) of the projection point P of a position point in the triangular patch are calculated.

If the projection point is on an edge of the triangular patch, the center-of-gravity coordinates have one zero component; or if the projection point is at a vertex of the triangular patch, the center-of-gravity coordinates have two zero components.

S703: Perform interpolation based on the center-of-gravity coordinates and absolute elevations of vertexes of the target patch, to obtain an absolute elevation of the projection point corresponding to the position point.

In this embodiment of this application, interpolation may be linear interpolation. Using an example in which the patch is a triangular patch, it is assumed that center-of-gravity coordinates of the projection point P in the triangular patch are: (λ₁,λ₂,λ₃), and absolute elevations of three vertexes of the triangular patch are respectively h₁, h₂, and h₃. Therefore, an absolute elevation of the projection point P obtained through interpolation in the triangular patch may be represented as:

hₚ=λ₁h₁+λ₂h₂+λ₃h₃ (6)
where hₚ may represent the absolute elevation of the projection point corresponding to the position point, and may be marked as currHeight. h₁, h₂, and h₃ are respectively the absolute elevations of the three vertexes of the triangular patch. λ₁, λ₂, and λ₃ are the center-of-gravity coordinates of the projection point P in the triangular patch.

When the terrain data is a three-dimensional terrain mesh including a triangular patch, and a constructed space index is RTree, for a procedure of determining an absolute elevation of a projection point, refer to FIG. 8. A plurality of position points are obtained (refer to S801 in FIG. 8), and a space index RTree of a three-dimensional terrain mesh is constructed (refer to S802 in FIG. 8). A plurality of position points are traversed (refer to S803 in FIG. 8), and when the traversing is not completed, a currently traversed position point is marked as currPoint (refer to S804 in FIG. 8). A target patch on which a projection point corresponding to the currPoint is located is searched for in the space index RTree (refer to S805 in FIG. 8), and an absolute elevation of the projection point is obtained through interpolation by using center-of-gravity coordinates of the projection point in the target patch (refer to S806 in FIG. 8). In this way, an operation of extracting an absolute elevation from real terrain data is completed.

In the foregoing manner, because the terrain data accurately records absolute elevations of vertexes of patches, the target patch to which the projection point corresponding to the target position point belongs is determined, and interpolation calculation is performed based on the absolute elevations of the vertexes of the target patch according to the center-of-gravity coordinates of the projection point in the target patch, to ensure that the calculated absolute elevation of the projection point is accurate.

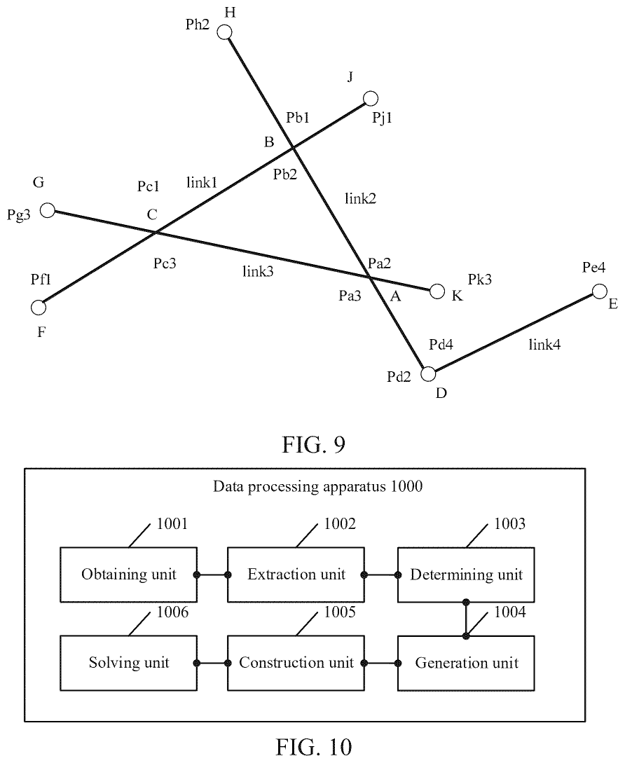

The data processing method provided in the embodiments of this application are described below with reference to a practical application scenario. In the application scenario, using an example in which the target elevation is an absolute elevation, the to-be-processed road includes link1, link2, link3, and link4, and a top view of link1, link2, link3, and link4 is shown in FIG. 9.

link1, link2, and link3 are respectively overlaid at points A, B, and C (that is, there is a road overlaying relationship), and link2 and link4 are connected at a point D (that is, there is a road adjacency relationship).

It is assumed that absolute elevations of projection points of points A, B, C, D, E, F, G, H, J, and K on the terrain data are respectively:

$${h}_{A}^{a} , {h}_{B}^{a} , {h}_{C}^{a} , {h}_{D}^{a} , {h}_{E}^{a} , {h}_{F}^{a} , {h}_{G}^{a} , {h}_{H}^{a} , {h}_{J}^{a} , and {h}_{K}^{a} .$$

The absolute elevations may be calculated in the manner described in S203, and is a known quantity.

It is assumed that link2 is higher than link3 at the point A, link1 is higher than link2 at the point B, and link1 is higher than link3 at the point C, that is, the height constraint of an overlaying area needs to satisfy:

hₐ₂−hₐ₃≥H

h_{b1}−h_{b2}≥H

h_{c1}−h_{c3}≥H
where hₐ₂ is a relative elevation parameter of a position point Pₐ₂ relative to the projection point on link2 at the point A, and hₐ₃ is a relative elevation parameter of a position point Pₐ₃ relative to the projection point on link3 at the point A; h_{b1} is a relative elevation parameter of a position point P_{b1} relative to the projection point on link1 at the point B, and h_{b2} is a relative elevation parameter of a position point P_{b2} relative to the projection point on link2 at the point B; and h_{c1} is a relative elevation parameter of a position point P_{c1} relative to the projection point on link1 at the point C, and h_{c3} is a relative elevation parameter of a position point P_{c3} relative to the projection point on link3 at the point C.
link2 and link4 are adjacent at the point D, that is, the adjacency height continuity constraint needs to satisfy:

h_{d2}=h_{d4}
where h_{d2} is a relative elevation parameter of a position point P_{d2} relative to the projection point on link2 at the point D, and h_{d4} is a relative elevation parameter of a position point P_{d4} relative to the projection point on link4 at the point D.
link1 is divided by the point B and the point C into three segments, and each segment needs to satisfy the road slope constraint, that is,

$$- {S}_{fc} {D}_{fc} \leq ( {h}_{F}^{a} + {h}_{f 1} ) - ( {h}_{C}^{a} + {h}_{c 1} ) \leq {S}_{fc} {D}_{fc}$$

$$- {S}_{c b} {D}_{c b} \leq ( {h}_{C}^{a} + {h}_{c 1} ) - ( {h}_{B}^{a} + {h}_{b 1} ) \leq {S}_{c b} {D}_{c b}$$

$$- {S}_{bj} {D}_{bj} \leq ( {h}_{B}^{a} + {h}_{b 1} ) - ( {h}_{J}^{a} + {h}_{j 1} ) \leq {S}_{bj} {D}_{bj}$$

where S_{fc}, S_{cb}, and S_{bj} are tangents of a maximum slope, and D_{fc}, D_{cb}, and D_{bj} are distances between the point F and the point C, between the point C and the point B, and between the point B and the point J on the plane, respectively. After two-dimensional position information of the position points are known, the distances can be calculated, and therefore are known quantities.

$${h}_{F}^{a} , {h}_{C}^{a} , {h}_{B}^{a} , and {h}_{J}^{a}$$

are respectively the absolute elevations of the projection points of F, C, B, and J on the terrain data. h_{f1} is a relative elevation parameter of a position point P_{f1} relative to the projection point on link1 at the point F, h_{c1} is a relative elevation parameter of a position point P_{c1} relative to the projection point on link1 at the point C, h_{b1} is a relative elevation parameter of a position point P_{b1} relative to the projection point on link1 at the point B, and hⱼ₁ is a relative elevation parameter of a position point Pⱼ₁ relative to the projection point on link1 at the point J.

Similarly, for link2, each segment needs to satisfy the road slope constraint:

$$- {S}_{h b} {D}_{h b} \leq ( {h}_{H}^{a} + {h}_{h 2} ) - ( {h}_{B}^{a} + {h}_{b 2} ) \leq {S}_{h b} {D}_{h b}$$

$$- {S}_{b a} {D}_{b a} \leq ( {h}_{B}^{a} + {h}_{b 2} ) - ( {h}_{A}^{a} + {h}_{a 2} ) \leq {S}_{b a} {D}_{b a}$$

$$- {S}_{a d} {D}_{a d} \leq ( {h}_{A}^{a} + {h}_{a 2} ) - ( {h}_{D}^{a} + {h}_{d 2} ) \leq {S}_{a d} {D}_{a d}$$

where S_{hb}, S_{ba}, and S_{ad} are tangents of a maximum slope, and D_{hb}, D_{ba}, and D_{ad} are distances between the point H and the point B, between the point B and the point A, and between the point A and the point D on the plane, respectively. After two-dimensional position information of the position points are known, the distances can be calculated, and therefore are known quantities.

$${h}_{H}^{a} , {h}_{B}^{a} , {h}_{A}^{a} , and {h}_{D}^{a}$$

are respectively the absolute elevations of the projection points of H, B, A, and D on the terrain data. hₕ₂ is a relative elevation parameter of a position point Pₕ₂ relative to the projection point on link2 at the point H, h_{b2} is a relative elevation parameter of a position point P_{b2} relative to the projection point on link2 at the point B, hₐ₂ is a relative elevation parameter of a position point Pₐ₂ relative to the projection point on link2 at the point A, and hₐ₂ is a relative elevation parameter of a position point P_{d2} relative to the projection point on link2 at the point D.

For link3, each segment needs to satisfy the road slope constraint:

$$- {S}_{g c} {D}_{g c} \leq ( {h}_{G}^{a} + {h}_{g 3} ) - ( {h}_{C}^{a} + {h}_{c 3} ) \leq {S}_{g c} {D}_{g c}$$

$$- {S}_{c a} {D}_{c a} \leq ( {h}_{C}^{a} + {h}_{c 3} ) - ( {h}_{A}^{a} + {h}_{a 3} ) \leq {S}_{c a} {D}_{c a}$$

$$- {S}_{a k} {D}_{a k} \leq ( {h}_{A}^{a} + {h}_{a 3} ) - ( {h}_{K}^{a} + {h}_{k 3} ) \leq {S}_{a k} {D}_{a k}$$

where S_{gc}, S_{ca}, and Sₐₖ are tangents of a maximum slope, and D_{gc}, D_{ca}, and Dₐₖ are distances between the point G and the point C, between the point C and the point A, and between the point A and the point K on the plane, respectively. After two-dimensional position information of the position points are known, the distances can be calculated, and therefore are known quantities.

$${h}_{G}^{a} , {h}_{C}^{a} , {h}_{A}^{a} , and {h}_{K}^{a}$$

are respectively the absolute elevations of the projection points of G, C, A, and K on the terrain data. h_{g3} is a relative elevation parameter of a position point P_{g3} relative to the projection point on link3 at the point G, h_{c3} is a relative elevation parameter of a position point P_{c3} relative to the projection point on link3 at the point C, hₐ₃ is a relative elevation parameter of a position point Pₐ₃ relative to the projection point on link3 at the point A, and hₖ₃ is a relative elevation parameter of a position point Pₖ₃ relative to the projection point on link3 at the point K.

For link4, each segment needs to satisfy the road slope constraint:

$$- {S}_{d e} {D}_{d e} \leq ( {h}_{D}^{a} + {h}_{d 4} ) - ( {h}_{E}^{a} + {h}_{e 4} ) \leq {S}_{d e} {D}_{d e}$$

where S_{de} is a tangent of a maximum slope, and D_{de} is a distance between the point D and the point E on the plane. After two-dimensional position information of the position points are known, the distances can be calculated, and therefore are known quantities.

$${h}_{D}^{a} , and {h}_{E}^{a}$$

are respectively the absolute elevations of the projection points of D and E on the terrain data. h_{d4} is a relative elevation parameter of a position point P_{d4} relative to the projection point on link4 at the point D, and hₑ₄ is a relative elevation parameter of a position point Pₑ₄ relative to the projection point on link4 at the point E.

The elevation distribution feature function is:

$$V = {h}_{f 1}^{2} + {h}_{c 1}^{2} + {h}_{b 1}^{2} + {h}_{j 1}^{2} + {h}_{h 2}^{2} + {h}_{b 2}^{2} + {h}_{a 2}^{2} + {h}_{d 2}^{2} + {h}_{g 3}^{2} + {h}_{c 3}^{2} + {h}_{a 3}^{2} + {h}_{k 3}^{2} + {h}_{d 4}^{2} + {h}_{e 4}^{2}$$

where V is an elevation distribution feature function, and h_{f1}, h_{c1}, h_{b1}, hⱼ₁, hₕ₂, h_{b2}, hₐ₂, h_{d2}, h_{g3}, h_{c3}, hₐ₃, hₖ₃, h_{d4}, and hₑ₄ are respectively relative elevation parameters of the position points P_{f1}, P_{c1}, P_{b1}, Pⱼ₁, Pₕ₂, P_{b2}, Pₐ₂, P_{d2}, P_{g3}, P_{c3}, Pₐ₃, Pₖ₃, P_{d4}, and Pₑ₄ relative to corresponding projection points.

Therefore, generating a relative elevation of a position point relative to a projection point corresponding to the position point is converted into solving the following optimization problem:

$$min V = min ( {h}_{f 1}^{2} + {h}_{c 1}^{2} + {h}_{b 1}^{2} + {h}_{j 1}^{2} + {h}_{h 2}^{2} + {h}_{b 2}^{2} + {h}_{a 2}^{2} + {h}_{d 2}^{2} + {h}_{g 3}^{2} + {h}_{c 3}^{2} + {h}_{a 3}^{2} + {h}_{k 3}^{2} + {h}_{d 4}^{2} + {h}_{e 4}^{2} )$$

$${h}_{a 2} - {h}_{a 3} \geq H$$

$${h}_{b 1} - {h}_{b 2} \geq H$$

$${h}_{c 1} - {h}_{a 3} \geq H$$

$$- {S}_{fc} {D}_{fc} \leq ( {h}_{F}^{a} + {h}_{f 1} ) - ( {h}_{C}^{a} + {h}_{c 1} ) \leq {S}_{fc} {D}_{fc}$$

$$- {S}_{c b} {D}_{c b} \leq ( {h}_{C}^{a} + {h}_{c 1} ) - ( {h}_{B}^{a} + {h}_{b 1} ) \leq {S}_{c b} {D}_{c b}$$

$$- {S}_{bj} {D}_{bj} \leq ( {h}_{B}^{a} + {h}_{b 1} ) - ( {h}_{1}^{a} + {h}_{j 1} ) \leq {S}_{b j} {D}_{b j}$$

$$- {S}_{h b} {D}_{h b} \leq ( {h}_{H}^{a} + {h}_{h 2} ) - ( {h}_{B}^{a} + {h}_{b 2} ) \leq {S}_{h b} {D}_{h b}$$

$$- {S}_{b a} {D}_{b a} \leq ( {h}_{B}^{a} + {h}_{b 2} ) - ( {h}_{A}^{a} + {h}_{a 2} ) \leq {S}_{b a} {D}_{b a}$$

$$- {S}_{a d} {D}_{a d} \leq ( {h}_{A}^{a} + {h}_{a 2} ) - ( {h}_{D}^{a} + {h}_{d 2} ) \leq {S}_{a d} {D}_{a d}$$

$$- {S}_{g c} {D}_{g c} \leq ( {h}_{G}^{a} + {h}_{g 3} ) - ( {h}_{C}^{a} + {h}_{c 3} ) \leq {S}_{g c} {D}_{g c}$$

$$- {S}_{c a} {D}_{c a} \leq ( {h}_{C}^{a} + {h}_{c 3} ) - ( {h}_{A}^{a} + {h}_{a 3} ) \leq {S}_{c a} {D}_{c a}$$

$$- {S}_{a k} {D}_{a k} \leq ( {h}_{A}^{a} + {h}_{a 3} ) - ( {h}_{K}^{a} + {h}_{k 3} ) \leq {S}_{a k} {D}_{a k}$$

$$- {S}_{d e} {D}_{d e} \leq ( {h}_{D}^{a} + {h}_{d 4} ) - ( {h}_{E}^{a} + {h}_{e 4} ) \leq {S}_{d e} {D}_{d e}$$

$${h}_{d 2} = {h}_{d 4}$$

where parameters in the formula are all described in the foregoing formulas, and details are not described herein again.

Currently, there are many mature mathematical tools that can be used for such a mathematical optimization problem, for example, an interior-point method in the convex optimization. Solving can be performed efficiently by using these mathematical tools.

After the relative elevations of all the position points relative to the corresponding projection points are calculated, the absolute elevations of the corresponding projection points further need to be added. In other words, the absolute elevations of F, C, B, and J on link1 are respectively:

$${h}_{f 1}^{a} = {h}_{F}^{a} + {h}_{f 1}$$

$${h}_{c 1}^{a} = {h}_{C}^{a} + {h}_{c 1}$$

$${h}_{b 1}^{a} = {h}_{B}^{a} + {h}_{b 1}$$

$${h}_{j 1}^{a} = {h}_{1}^{a} + {h}_{j 1}$$

where

$${h}_{f 1}^{a} , {h}_{c 1}^{a} , {h}_{b 1}^{a} , and {h}_{j 1}^{a}$$

are respectively the absolute elevations at F, C, B, and J on link1, other parameters are all introduced in the foregoing formulas, and details are not described herein again.

The absolute elevations of H, B, A, and D on link2 are respectively:

$${h}_{h 2}^{a} = {h}_{H}^{a} + {h}_{h 2}$$

$${h}_{b 2}^{a} = {h}_{B}^{a} + {h}_{b 2}$$

$${h}_{a 2}^{a} = {h}_{A}^{a} + {h}_{a 2}$$

$${h}_{d 2}^{a} = {h}_{D}^{a} + {h}_{d 2}$$

where

$${h}_{h 2}^{a} , {h}_{b 2}^{a} , {h}_{a 2}^{a} {and}_{d 2}^{a}$$

are respectively absolute elevations at H, B, A, and D on link2, other parameters are all introduced in the foregoing formulas, and details are not described herein again.

The absolute elevations of G, C, A, and K on link3 are respectively:

$${h}_{g 3}^{a} = {h}_{G}^{a} + {h}_{g 3}$$

$${h}_{c 3}^{a} = {h}_{C}^{a} + {h}_{c 3}$$

$${h}_{a 3}^{a} = {h}_{A}^{a} + {h}_{a 3}$$

$${h}_{k 3}^{a} = {h}_{K}^{a} + {h}_{k 3}$$

where

$${h}_{g 3}^{a} , {h}_{c 3}^{a} , {h}_{a 3}^{a} , and {h}_{k 3}^{a}$$

are respectively absolute elevations at G, C, A, and K on link3, other parameters are all introduced in the foregoing formulas, and details are not described herein again.

The absolute elevations of D and E on link4 are respectively:

$${h}_{d 4}^{a} = {h}_{D}^{a} + {h}_{d 4}$$

$${h}_{e 4}^{a} = {h}_{E}^{a} + {h}_{e 4}$$

where

$${h}_{d 4}^{a} and {h}_{e 4}^{a}$$

are respectively absolute elevations at D, E on link4, other parameters are all introduced in the foregoing formulas, and details are not described herein again.

After the absolute elevations of the position points are obtained, interpolation is performed to obtain heights of other position points on the to-be-processed road. For example, for link1, after the absolute elevations of the point C and the point F are calculated, linear interpolation is used to calculate absolute elevations of all position points between CF. The same approach applies to other roads, and details are not described herein again.

According to this embodiment of this application, the disclosed two types of low-cost data, namely, the real terrain data and the two-dimensional map data, are integrated to construct an optimization calculation model, so that a road elevation effect that has a correct road overlaying relationship, and continuous and smooth transition, and that is as close as possible to a real terrain can be generated, thereby further improving a sense of reality of a road elevation, and providing stronger immersion to a user. In an entire solving process, no additional prior knowledge is needed, no manual intervention is needed, and fully automatic and low-cost calculation can be performed.

In this application, based on the implementations provided in the foregoing aspects, further combinations may be performed to provide more implementations.

Based on the data processing method provided in the embodiment corresponding to FIG. 2, an embodiment of this application further provides a data processing apparatus 1000. Refer to FIG. 10, the data processing apparatus 1000 includes an obtaining unit 1001, an extraction unit 1002, a determining unit 1003, a generation unit 1004, a construction unit 1005, and a solving unit 1006.

The obtaining unit 1001 is configured to obtain terrain data corresponding to a to-be-processed road and two-dimensional map data corresponding to the to-be-processed road;
the obtaining unit 1001 is further configured to obtain a plurality of position points on the to-be-processed road from the two-dimensional map data;
the extraction unit 1002 is configured to extract, from the terrain data, absolute elevations of projection points respectively corresponding to the plurality of position points;
the determining unit 1003 is configured to determine a position relationship between the plurality of position points based on the two-dimensional map data;
the generation unit 1004 is configured to generate an elevation constraint condition set corresponding to the plurality of position points according to the position relationship, the elevation constraint condition set being configured for indicating conditions that need to be met by elevations respectively corresponding to the plurality of position points, and a target elevation corresponding to each position point being represented by using a relative elevation parameter of the position point relative to a projection point corresponding to the position point;
the construction unit 1005 is configured to construct an elevation distribution feature function by using the relative elevation parameters respectively corresponding to the plurality of position points;
the solving unit 1006 is configured to perform parameter solving on the relative elevation parameters based on the elevation distribution feature function and the elevation constraint condition set, to obtain relative elevations respectively corresponding to the plurality of position points; and
the determining unit 1003 is further configured to determine, for each position point, an absolute elevation of the position point based on the relative elevation of the position point and an absolute elevation of the projection point corresponding to the position point.

In a possible implementation, the terrain data is a three-dimensional terrain mesh formed by a plurality of patches, and the extraction unit 1002 is configured to:
determine, for each position point, a target patch to which the projection point corresponding to the position point belongs;
determine center-of-gravity coordinates of the projection point corresponding to the position point in the target patch; and
perform interpolation based on the center-of-gravity coordinates and absolute elevations of vertexes of the target patch, to obtain the absolute elevation of the projection point corresponding to the position point.

In a possible implementation, the extraction unit 1002 is configured to:
create a space index of the plurality of patches included in the three-dimensional terrain mesh;
query, by using the space index, for candidate patches corresponding to the position point; and
determine the target patch to which the projection point corresponding to the position point belongs from the candidate patches.

In a possible implementation, the extraction unit 1002 is configured to:
determine, if the projection point corresponding to the position point is located on a target edge or at a target vertex of the three-dimensional terrain mesh, any patch on which the target edge or the target vertex is located as the target patch.

In a possible implementation, the obtaining unit 1001 is configured to:
obtain a start point and an end point of the to-be-processed road; and
obtain an overlaying point of the to-be-processed road if it is determined, based on the two-dimensional map data, that a road relationship corresponding to the to-be-processed road includes a road overlaying relationship, and determine the overlaying point, the start point, and the end point as the plurality of position points, the overlaying point being a position point located at an overlaying position on the to-be-processed road; or
determine the start point and the end point of the to-be-processed road as the plurality of position points if it is determined, based on the two-dimensional map data, that a road relationship corresponding to the to-be-processed road does not include a road overlaying relationship.

In a possible implementation, the determining unit 1003 is configured to:
obtain, from the plurality of position points, any two neighboring position points belonging to a same to-be-processed road;
determine that the two neighboring position points have a neighboring relationship;
determine a road relationship corresponding to the to-be-processed road based on the two-dimensional map data; and
determine the position relationship between the plurality of position points according to the road relationship corresponding to the to-be-processed road and the neighboring relationship.

In a possible implementation, the determining unit 1003 is configured to:
obtain, if the road relationship includes the road overlaying relationship, position points corresponding to an overlaying position from the to-be-processed road having the road overlaying relationship, and determine that the position points corresponding to the same overlaying position have an upper-lower relationship; and
determine the upper-lower relationship and the neighboring relationship as the position relationship between the plurality of position points.

In a possible implementation, the determining unit 1003 is configured to:
obtain, if the road relationship includes a road adjacency relationship, position points corresponding to a connection position from the to-be-processed road having the road adjacency relationship, and determine that the position points corresponding to the same connection position have an adjacency relationship; and
determine the adjacency relationship and the neighboring relationship as the position relationship between the plurality of position points.

In a possible implementation, the generation unit 1004 is configured to:
obtain, according to the position relationship between the plurality of position points, a position point pair having the position relationship;
generate an elevation constraint condition corresponding to the position point pair according to the position relationship of the position point pair; and
construct the elevation constraint condition set based on elevation constraint conditions respectively corresponding to position point pairs.

In a possible implementation, the generation unit 1004 is configured to:
generate, if the position relationship of the position point pair is the upper-lower relationship, the elevation constraint condition corresponding to the position point pair according to upper-lower elevation information of the two position points in the position point pair and a height difference threshold;
generate, if the position relationship of the position point pair is the neighboring relationship, the elevation constraint condition corresponding to the position point pair according to two-dimensional position information respectively corresponding to the two position points in the position point pair and a slope threshold; or
generate, if the position relationship of the position point pair is the adjacency relationship, an elevation constraint condition configured for indicating that the two position points in the position point pair are connected as the elevation constraint condition corresponding to the position point pair.

In a possible implementation, the solving unit 1006 is configured to:
obtain an initial relative elevation corresponding to each relative elevation parameter, and determine, based on the plurality of initial relative elevations and the elevation distribution feature function, initial distribution feature information corresponding to the plurality of initial relative elevations; and
respectively adjust the plurality of initial relative elevations based on the initial distribution feature information and the elevation constraint condition set, to obtain the relative elevations respectively corresponding to the plurality of position points.

In a possible implementation, the plurality of position points are a part of position points on the to-be-processed road, and the determining unit 1003 is further configured to:
obtain, from the two-dimensional map data, another position point on the to-be-processed road other than the plurality of position points, as an intermediate position point;
obtain, from the plurality of position points, a position point having a neighboring association relationship with the intermediate position point as a reference position point;
perform interpolation according to an absolute elevation of the reference position point, to obtain an absolute elevation of the intermediate position point; and
determine the absolute elevations respectively corresponding to the plurality of position points and the absolute elevation of the intermediate position point as an absolute elevation of the to-be-processed road.

In a possible implementation, the elevation is an absolute elevation, and an elevation corresponding to each position point is represented by using a relative elevation parameter of the position point relative to a projection point corresponding to the position point and an absolute elevation of the projection point corresponding to the position point.

It can be seen from the foregoing technical solution that, a plurality of position points of a to-be-processed road are obtained from two-dimensional map data, and then absolute elevations of projection points respectively corresponding to the plurality of position points are extracted from terrain data. The absolute elevation is extracted from real terrain data. Because the terrain data can truly reflect a real terrain such as undulations of the terrain, the determined absolute elevation of the projection point is relatively accurate. The relative elevation of the position point is then determined, and in a process of determining the relative elevation, the determining of the relative elevation is converted into solving for a relative elevation parameter. Specifically, an elevation constraint condition set corresponding to the plurality of position points may be generated according to a determined position relationship between the plurality of position points. The elevation constraint condition set is configured for indicating conditions that need to be met by elevations respectively corresponding to the plurality of position points, and the elevation corresponding to each position point is represented by using a relative elevation parameter of the position point relative to a projection point corresponding to the position point. A specific value of the relative elevation parameter is unknown, that is, needs to be solved for. Therefore, an elevation distribution feature function may be constructed by using relative elevation parameters respectively corresponding to the plurality of position points, and parameter solving is performed on the relative elevation parameters based on the elevation distribution feature function and the elevation constraint condition set, to obtain relative elevations respectively corresponding to the plurality of position points. An absolute elevation of a position point is then obtained based on a relative elevation of the position point and an absolute elevation of a projection point corresponding to the position point. The absolute elevation can more accurately reflect a real height of a road. When road rendering is performed based on the absolute elevation, a road rendering effect can be improved, further improving a sense of reality of a road elevation, and providing stronger immersion to a user.

An embodiment of this application further provides a computer device. The computer device may perform the data processing method. The computer device may be a terminal. An example in which the terminal is a smartphone is used.

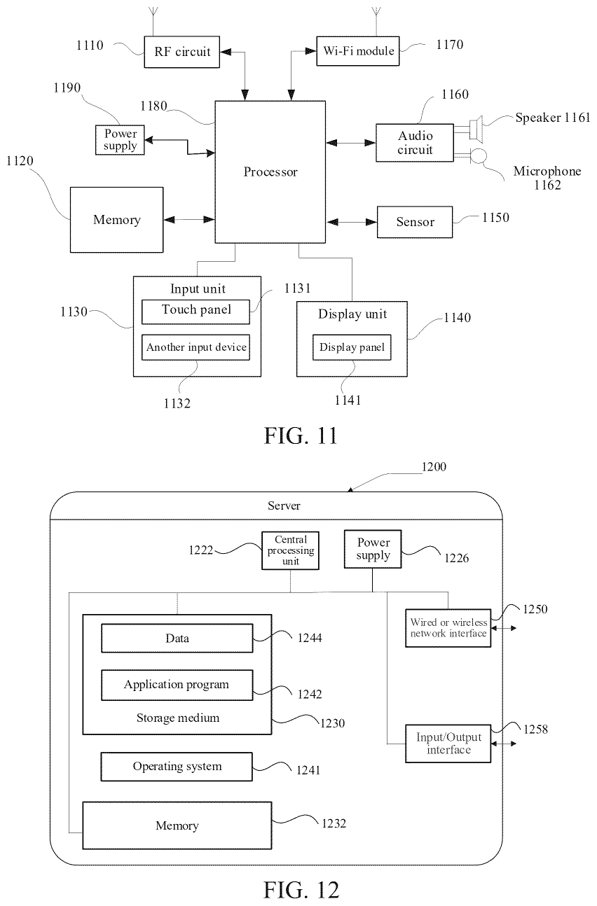

FIG. 11 is a block diagram of a partial structure of a smartphone according to an embodiment of this application. Refer to FIG. 11. The smartphone includes components such as a radio frequency (RF) circuit 1110, a memory 1120, an input unit 1130, a display unit 1140, a sensor 1150, an audio circuit 1160, a wireless fidelity (Wi-Fi) module 1170, a processor 1180, and a power supply 1190. The input unit 1130 may include a touch panel 1131 and another input device 1132. The display unit 1140 may include a display panel 1141. The audio circuit 1160 may include a speaker 1161 and a microphone 1162. The structure of the smartphone shown in FIG. 11 does not constitute a limitation to the smartphone. The smartphone may include more or fewer components than those shown, or some components may be combined, or different component arrangements may be used.

The memory 1120 may be configured to store a software program and a module, and the processor 1180 executes various function applications of the smartphone and performs data processing by running the software program and the module stored in the memory 1120. The memory 1120 may mainly include a program storage area and a data storage area. The program storage area may store an operating system, an application program required by at least one function (such as a sound playback function and an image display function), and the like. The data storage area may store data (such as audio data and a phone book) created according to the use of the mobile phone, and the like. In addition, the memory 1120 may include a high speed random access memory, and may also include a non-volatile memory, for example, at least one magnetic disk storage device, a flash memory, or another volatile solid-state memory.

The processor 1180 is a control center of the smartphone, and is connected to various parts of the entire smartphone by using various interfaces and lines. By running or executing the software program and/or the module stored in the memory 1120, and invoking data stored in the memory 1120, the processor executes various functions of the smartphone and processes the data. In some embodiments, the processor 1180 may include one or more processing units. Preferably, an application processor and a modem processor may be integrated into the processor 1180. The application processor mainly processes an operating system, a user interface, an application program, and the like. The modem processor mainly processes wireless communication. The modem processor may alternatively not be integrated into the processor 1180.

In this embodiment, the processor 1180 in the smartphone may perform the data processing method provided in the embodiments of this application.

The computer device provided in this embodiment of this application may alternatively be a server. Refer to FIG. 12. FIG. 12 is a structural diagram of a server 1200 according to an embodiment of this application. The server 1200 may vary greatly due to different configurations or performance, and may include one or more processors, for example, central processing units (CPU) 1222, a memory 1232, and one or more storage media 1230 (for example, one or more mass storage devices) that store application programs 1242 or data 1244. The memory 1232 and the storage medium 1230 may be configured for transient storage or permanent storage. The program stored in the storage medium 1230 may include one or more modules (not marked in the figure), and each module may include a series of instruction operations to the server. Further, the central processing unit 1222 may be configured to communicate with the storage medium 1230, and perform, on the server 1200, a series of instruction operations in the storage medium 1230.

The server 1200 may further include one or more power supplies 1226, one or more wired or wireless network interfaces 1250, one or more input/output interfaces 1258, and/or one or more operating systems 1241, such as Windows Server™, Mac OS X™, Unix™, Linux™, and FreeBSD™.

In this embodiment, the central processing unit 1222 in the server 1200 may perform the data processing method provided in the embodiments of this application.

According to an aspect of this application, a non-transitory computer-readable storage medium is provided. The computer-readable storage medium is configured to store a computer program. The computer program is configured to perform the data processing method described in the foregoing embodiments.

According to an aspect of this application, a computer program product is provided. The computer program product includes a computer program, and the computer program is stored in a non-transitory computer-readable storage medium. A processor of a computer device reads the computer program from the computer-readable storage medium, and the processor executes the computer program, to cause the computer device to perform the method provided in various exemplary implementations of the foregoing embodiments.

The descriptions of procedures or structures corresponding to the foregoing drawings have different emphases, and parts not described in detail in a process or structure may refer to the related descriptions of other procedures or structures.

The terms “first”, “second”, “third”, “fourth”, and the like (if any) in the specification of this application and the foregoing accompanying drawings are configured for distinguishing similar objects and are not necessarily configured for describing a particular order or sequence. Data used in this way is interchangeable in a suitable case, so that the embodiments of this application described herein can, for example, be implemented in an order other than those illustrated or described herein. In addition, the terms “comprise”, “include”, “have”, and any variants thereof are intended to cover the non-exclusive inclusion. For example, a process, method, system, product, or device that includes a series of steps or units is not necessarily limited to those steps or units expressly listed, but can include other steps or units not expressly listed or inherent to such a process, method, product, or device.

In several embodiments provided in this application, the system, apparatus, and method disclosed may be implemented in other manners. For example, the described apparatus embodiments are only exemplary. For example, the division of the units is only a logical function division and may be other divisions during actual implementation. For example, a plurality of units or components may be combined or integrated into another system, or some features may be ignored or not performed. In addition, mutual coupling or direct coupling, or communication connection displayed or discussed may be implemented through some interfaces. Indirect coupling or communication connection between the apparatuses or units may be electronic, mechanical, or the like.

The units described as separate components may or may not be physically separate, and components displayed as units may or may not be physical units, may be located in one place, or may be distributed on a plurality of network units. Some or all of the units may be selected according to actual needs to achieve the objectives of the solution in the embodiments.

In addition, function units in the embodiments of this application may be integrated into one processing unit, the units may be physically separated, or two or more units may be integrated into one unit. The above integrated unit may be implemented in a form of hardware or a software function unit.

If the integrated unit is implemented in the form of the software function unit and is sold or used as an independent product, the integrated unit may be stored in a non-transitory computer-readable storage medium. Based on such an understanding, the technical solutions of this application essentially, or the part contributing to the related art, or all or a part of the technical solutions may be implemented in a form of a software product. The computer software product is stored in a storage medium and includes several instructions for instructing a computer device (which may be a terminal, a server, a network device, or the like) to perform all or some of the steps of the method described in the embodiments of this application. The foregoing storage medium includes various media that can store computer programs, such as a USB flash drive, a mobile hard disk, a read-only memory (ROM), a random access memory (RAM), a magnetic disk, or a compact disc.

The foregoing embodiments are merely intended for describing the technical solutions of this application, but not for limiting this application. A person of ordinary skill in the art needs to understand that although this application has been described in detail with reference to the foregoing embodiments, modifications may be made to the technical solutions described in the foregoing embodiments, or equivalent replacements may be made to some technical features in the technical solutions. Such modifications or replacements do not cause the essence of the corresponding technical solution to depart from the spirit and scope of the technical solutions in the embodiments of this application.

What is claimed is:

1. A data processing method performed by a computer device, the method comprising:
obtaining terrain data and two-dimensional map data corresponding to a target road;
extracting, from the two-dimensional map data, a plurality of position points on the target road;
extracting, from the terrain data, absolute elevations of projection points respectively corresponding to the plurality of position points;
generating an elevation constraint condition set corresponding to the plurality of position points according to a position relationship between the plurality of position points based on the two-dimensional map data;
determining relative elevation parameters respectively corresponding to the plurality of position points based on the elevation constraint condition set; and
determining, for each position point, an absolute elevation of the position point based on the relative elevation of the position point and an absolute elevation of a projection point corresponding to the position point.

2. The method according to claim 1, wherein the elevation constraint condition set indicates conditions that need to be met by respective elevations of the plurality of position points.

3. The method according to claim 1, wherein the terrain data is a three-dimensional terrain mesh formed by a plurality of patches, and the extracting, from the terrain data, absolute elevations of projection points respectively corresponding to the plurality of position points comprises:
determining, for each position point, a target patch to which the projection point corresponding to the position point belongs;
determining center-of-gravity coordinates of the projection point corresponding to the position point in the target patch; and
performing interpolation based on the center-of-gravity coordinates and absolute elevations of vertexes of the target patch, to obtain the absolute elevation of the projection point corresponding to the position point.

4. The method according to claim 3, wherein the determining a target patch to which the projection point corresponding to the position point belongs comprises:
creating a space index of the plurality of patches comprised in the three-dimensional terrain mesh;
querying, by using the space index, for candidate patches corresponding to the position point; and
determining the target patch to which the projection point corresponding to the position point belongs from the candidate patches.

5. The method according to claim 3, wherein the determining a target patch to which the projection point corresponding to the position point belongs comprises:
determining, if the projection point corresponding to the position point is located on a target edge or at a target vertex of the three-dimensional terrain mesh, any patch on which the target edge or the target vertex is located as the target patch.

6. The method according to claim 1, wherein the extracting, from the two-dimensional map data, a plurality of position points on the target road comprises:
obtaining a start point and an end point of the target road; and
obtaining an overlaying point of the target road based on the two-dimensional map data when a road relationship corresponding to the to-be-processed road comprises a road overlaying relationship;
determining the overlaying point, the start point, and the end point as the plurality of position points, the overlaying point being a position point located at an overlaying position on the to-be-processed road; and
determining the start point and the end point as the plurality of position points based on the two-dimensional map data when a road relationship corresponding to the target road does not comprise a road overlaying relationship.

7. The method according to claim 1, wherein the position relationship between the plurality of position points based on the two-dimensional map data is determined by:
obtaining, from the plurality of position points, any two neighboring position points belonging to the target road;
determining that the two neighboring position points have a neighboring relationship;
determining a road relationship corresponding to the target road based on the two-dimensional map data; and
determining the position relationship between the plurality of position points according to the road relationship corresponding to the target road and the neighboring relationship.

8. The method according to claim 1, wherein the generating an elevation constraint condition set corresponding to the plurality of position points according to the position relationship comprises:
obtaining, according to the position relationship between the plurality of position points, a position point pair having the position relationship;
generating an elevation constraint condition corresponding to the position point pair according to the position relationship of the position point pair; and
constructing the elevation constraint condition set based on elevation constraint conditions respectively corresponding to position point pairs.

9. The method according to any claim 1, wherein the determining relative elevation parameters respectively corresponding to the plurality of position points based on the elevation constraint condition set comprises:
obtaining an initial relative elevation corresponding to each relative elevation parameter, and determining, based on the plurality of initial relative elevations, initial distribution feature information corresponding to the plurality of initial relative elevations; and
respectively adjusting the plurality of initial relative elevations based on the initial distribution feature information and the elevation constraint condition set, to obtain the relative elevations respectively corresponding to the plurality of position points.

10. The method according to claim 1, wherein the method further comprises:
obtaining, from the two-dimensional map data, another position point on the to-be-processed road other than the plurality of position points, as an intermediate position point;
obtaining, from the plurality of position points, a position point having a neighboring association relationship with the intermediate position point as a reference position point;
performing interpolation according to an absolute elevation of the reference position point, to obtain an absolute elevation of the intermediate position point; and
determining the absolute elevations respectively corresponding to the plurality of position points and the absolute elevation of the intermediate position point as an absolute elevation of the target road.

11. A computer device, comprising a processor and a memory,
the memory being configured to: store a computer program, and transmit the computer program to the processor; and
the processor being configured to perform a data processing method according to instructions in the computer program, the method including:
obtaining terrain data and two-dimensional map data corresponding to a target road;
extracting, from the two-dimensional map data, a plurality of position points on the target road;
extracting, from the terrain data, absolute elevations of projection points respectively corresponding to the plurality of position points;
generating an elevation constraint condition set corresponding to the plurality of position points according to a position relationship between the plurality of position points based on the two-dimensional map data;
determining relative elevation parameters respectively corresponding to the plurality of position points based on the elevation constraint condition set; and
determining, for each position point, an absolute elevation of the position point based on the relative elevation of the position point and an absolute elevation of a projection point corresponding to the position point.

12. The computer device according to claim 11, wherein the elevation constraint condition set indicates conditions that need to be met by respective elevations of the plurality of position points.

13. The computer device according to claim 11, wherein the terrain data is a three-dimensional terrain mesh formed by a plurality of patches, and the extracting, from the terrain data, absolute elevations of projection points respectively corresponding to the plurality of position points comprises:
determining, for each position point, a target patch to which the projection point corresponding to the position point belongs;
determining center-of-gravity coordinates of the projection point corresponding to the position point in the target patch; and
performing interpolation based on the center-of-gravity coordinates and absolute elevations of vertexes of the target patch, to obtain the absolute elevation of the projection point corresponding to the position point.

14. The computer device according to claim 11, wherein the extracting, from the two-dimensional map data, a plurality of position points on the target road comprises:
obtaining a start point and an end point of the target road; and
obtaining an overlaying point of the target road based on the two-dimensional map data when a road relationship corresponding to the to-be-processed road comprises a road overlaying relationship;
determining the overlaying point, the start point, and the end point as the plurality of position points, the overlaying point being a position point located at an overlaying position on the to-be-processed road; and
determining the start point and the end point as the plurality of position points based on the two-dimensional map data when a road relationship corresponding to the target road does not comprise a road overlaying relationship.

15. The computer device according to claim 11, wherein the position relationship between the plurality of position points based on the two-dimensional map data is determined by:
obtaining, from the plurality of position points, any two neighboring position points belonging to the target road;
determining that the two neighboring position points have a neighboring relationship;
determining a road relationship corresponding to the target road based on the two-dimensional map data; and
determining the position relationship between the plurality of position points according to the road relationship corresponding to the target road and the neighboring relationship.

16. The computer device according to claim 11, wherein the generating an elevation constraint condition set corresponding to the plurality of position points according to the position relationship comprises:
obtaining, according to the position relationship between the plurality of position points, a position point pair having the position relationship;
generating an elevation constraint condition corresponding to the position point pair according to the position relationship of the position point pair; and
constructing the elevation constraint condition set based on elevation constraint conditions respectively corresponding to position point pairs.

17. The computer device according to claim 11, wherein the determining relative elevation parameters respectively corresponding to the plurality of position points based on the elevation constraint condition set comprises:
obtaining an initial relative elevation corresponding to each relative elevation parameter, and determining, based on the plurality of initial relative elevations, initial distribution feature information corresponding to the plurality of initial relative elevations; and
respectively adjusting the plurality of initial relative elevations based on the initial distribution feature information and the elevation constraint condition set, to obtain the relative elevations respectively corresponding to the plurality of position points.

18. The computer device according to claim 11, wherein the method further comprises:
obtaining, from the two-dimensional map data, another position point on the to-be-processed road other than the plurality of position points, as an intermediate position point;
obtaining, from the plurality of position points, a position point having a neighboring association relationship with the intermediate position point as a reference position point;
performing interpolation according to an absolute elevation of the reference position point, to obtain an absolute elevation of the intermediate position point; and
determining the absolute elevations respectively corresponding to the plurality of position points and the absolute elevation of the intermediate position point as an absolute elevation of the target road.

19. A non-transitory computer-readable storage medium, configured to store a computer program, the computer program, when executed by a processor of a computer device, enabling the computer device to perform a data processing method including:
obtaining terrain data and two-dimensional map data corresponding to a target road;
extracting, from the two-dimensional map data, a plurality of position points on the target road;
extracting, from the terrain data, absolute elevations of projection points respectively corresponding to the plurality of position points;
generating an elevation constraint condition set corresponding to the plurality of position points according to a position relationship between the plurality of position points based on the two-dimensional map data;
determining relative elevation parameters respectively corresponding to the plurality of position points based on the elevation constraint condition set; and
determining, for each position point, an absolute elevation of the position point based on the relative elevation of the position point and an absolute elevation of a projection point corresponding to the position point.

20. The non-transitory computer-readable storage medium according to claim 19, wherein the elevation constraint condition set indicates conditions that need to be met by respective elevations of the plurality of position points.
